(19) United States
(12) Patent Application Publication
(10) Pub. No.: US 2013/0238785 A1
(43) Pub. Date: Sep. 12, 2013

(54) System and Method for Metadata Discovery and Metadata-Aware Scheduling

(71) Applicants: Ryan Hawk, San Antonio, TX (US); William Kelly, San Antonio, TX (US); Joseph Breu, Cibolo, TX (US); Jason L. Mick, Converse, TX (US)

(72) Inventors: Ryan Hawk, San Antonio, TX (US); William Kelly, San Antonio, TX (US); Joseph Breu, Cibolo, TX (US); Jason L. Mick, Converse, TX (US)

(73) Assignee: Rackspace US, Inc., San Antonio, TX (US)

(21) Appl. No.: 13/491,866

(22) Filed: Jun. 8, 2012

Related U.S. Application Data
(60) Provisional application No. 61/607,323, filed on Mar. 6, 2012.

(51) Int. Cl. G06F 15/173; G06F 9/455

(52) U.S. Cl. 709/224

(57) ABSTRACT

A cloud computing system including a plurality of computing devices configured to host virtual machine instances, each computing device in the plurality of computing devices including a monitor operable to collect metadata about the associated computing device. The system also includes a registry operable to receive and store the metadata from the plurality of computing devices and a scheduler operable to select a host computing device out of the plurality of computing devices on which to instantiate a virtual machine instance based on the metadata stored in the registry.

This application claims the benefit of U.S. provisional patent application 61/607,323, filed Mar. 6, 2012, entitled “Deploying Instances on Heterogeneous Hardware Using Availability Zones,” the entirely of which is incorporated by reference herein.

### BACKGROUND

The present disclosure relates generally to cloud computing, and more particularly to utilizing spare resources of a cloud computing system.

Cloud computing services can provide computational capacity, data access, networking/routing and storage services via a large pool of shared resources operated by a cloud computing provider. Because the computing resources are delivered over a network, cloud computing is location-independent computing, with all resources being provided to end-users on demand with control of the physical resources separated from control of the computing resources.

Originally the term cloud came from a diagram that contained a cloud-like shape to contain the services that afforded computing power that was harnessed to get work done. Much like the electrical power we receive each day, cloud computing is a model for enabling access to a shared collection of computing resources—networks for transfer, servers for storage, and applications or services for completing work. More specifically, the term “cloud computing” describes a consumption and delivery model for IT services based on the Internet, and it typically involves over-the-Internet provisioning of dynamically scalable and often virtualized resources. This frequently takes the form of web-based tools or applications that users can access and use through a web browser as if it was a program installed locally on their own computer. Details are abstracted from consumers, who no longer have need for expertise in, or control over, the technology infrastructure “in the cloud” that supports them. Most cloud computing infrastructures consist of services delivered through common centers and built on servers. Clouds often appear as single points of access for consumers' computing needs, and do not require end-user knowledge of the physical location and configuration of the system that delivers the services.

The utility model of cloud computing is useful because many of the computers in place in data centers today are underutilized in computing power and networking bandwidth. People may briefly need a large amount of computing capacity to complete a computation for example, but may not need the computing power once the computation is done. The cloud computing utility model provides computing resources on an on-demand basis with the flexibility to bring it up or down through automation or with little intervention.

As a result of the utility model of cloud computing, there are a number of aspects of cloud-based systems that can present challenges to existing application infrastructure. First, clouds should enable self-service, so that users can provision servers and networks with little human intervention. Second, network access is necessary. Because computational resources are delivered over the network, the individual service endpoints need to be network-addressable over standard protocols and through standardized mechanisms. Third, multi-tenancy. Clouds are designed to serve multiple consumers according to demand, and it is important that resources be shared fairly and that individual users not suffer performance degradation. Fourth, elasticity. Clouds are designed for rapid creation and destruction of computing resources, typically based upon virtual containers. Provisioning these different types of resources must be rapid and scale up or down based on need. Further, the cloud itself as well as applications that use cloud computing resources must be prepared for impermanent, fungible resources; application or cloud state must be explicitly managed because there is no guaranteed permanence of the infrastructure. Fifth, clouds typically provide metered or measured service—like utilities that are paid for by the hour, clouds should optimize resource use and control it for the level of service or type of servers such as storage or processing.

Cloud computing offers different service models depending on the capabilities a consumer may require, including SaaS, PaaS, and IaaS-style clouds. SaaS (Software as a Service) clouds provide the users the ability to use software over the network and on a distributed basis. SaaS clouds typically do not expose any of the underlying cloud infrastructure to the user. PaaS (Platform as a Service) clouds provide users the ability to deploy applications through a programming language or tools supported by the cloud platform provider. Users interact with the cloud through standardized APIs, but the actual cloud mechanisms are abstracted away. Finally, IaaS (Infrastructure as a Service) clouds provide computer resources that mimic physical resources, such as computer instances, network connections, and storage devices. The actual scaling of the instances may be hidden from the developer, but users are required to control the scaling infrastructure.

One way in which different cloud computing systems may differ from each other is in how they deal with control of the underlying hardware and privacy of data. The different approaches are sometimes referred to a “public clouds,” “private clouds,” “hybrid clouds,” and “multi-vendor clouds.” A public cloud has an infrastructure that is available to the general public or a large industry group and is likely owned by a cloud services company. A private cloud operates for a single organization, but can be managed on-premise or off-premise. A hybrid cloud can be a deployment model, as a composition of both public and private clouds, or a hybrid model for cloud computing may involve both virtual and physical servers. A multi-vendor cloud is a hybrid cloud that may involve multiple public clouds, multiple private clouds, or some mixture.

Because the flow of services provided by the cloud is not directly under the control of the cloud computing provider, cloud computing requires the rapid and dynamic creation and destruction of computational units, frequently realized as virtualized resources. Maintaining the reliable flow and delivery of dynamically changing computational resources on top of a pool of limited and less-reliable physical servers provides unique challenges.

Most cloud systems assume a relatively homogenous pool of underlying computing resources, on top of which a homogenous pool of virtualized resources is instantiated. This is a useful abstraction, but it ignores the underlying differences in hardware. Even when the hardware and virtualized environments are identical, they still vary relative to relative latency, load due to multi-tenancy, disk activity, and differences in performance of the underlying hardware. Further, private clouds especially are created from repurposed servers from other projects or from a pool of unused servers. The hardware components of these servers can vary significantly, causing instance performance variances based on the capabilities of the host compute node for a particular instance. Accordingly, it is desirable to provide a better-functioning cloud computing system with superior operational capabilities.

### BRIEF DESCRIPTION OF THE DRAWINGS

FIG. 1 is a schematic view illustrating an external view of a cloud computing system.

FIG. 2a is a schematic view illustrating an information processing system as used in various embodiments.

FIG. 2b is a schematic view illustrating an IPMI subsystem as used in various embodiments.

FIG. 3 is a virtual machine management system as used in various embodiments.

FIG. 4a is a diagram showing types of network access available to virtual machines in a cloud computing system according to various embodiments.

FIG. 4b is a flowchart showing the establishment of a VLAN for a project according to various embodiments.

FIG. 5a shows a message service system according to various embodiments.

FIG. 5b is a diagram showing how a directed message is sent using the message service according to various embodiments.

FIG. 5c is a diagram showing how a broadcast message is sent using the message service according to various embodiments.

FIG. 6 shows IaaS-style computational cloud service according to various embodiments.

FIG. 7 shows an instantiating and launching process for virtual resources according to various embodiments.

FIG. 8 illustrates a system 800 that includes the compute cluster, the compute manager, and scheduler that were previously discussed in association with FIG. 6.

FIG. 9 illustrates a system 900 that is similar to the system of FIG. 8 but also includes a second compute cluster.

FIG. 10 illustrates a simplified flow chart of a method for metadata discovery and metadata-aware scheduling according to aspects of the present disclosure.

FIG. 11 illustrates is a system that includes a plurality of compute clusters and availability zones defined within the compute clusters.

### SUMMARY OF THE INVENTION

In one exemplary aspect, the present disclosure is directed to a cloud computing system. The system includes a plurality of computing devices configured to host virtual machine instances, each computing device in the plurality of computing devices including a monitor operable to collect metadata about the associated computing device. The system also includes a registry operable to receive and store the metadata from the plurality of computing devices and a scheduler operable to select a host computing device out of the plurality of computing devices on which to instantiate a virtual machine instance based on the metadata stored in the registry.

In another exemplary aspect, the present disclosure is directed to a cloud computing system. The system includes a plurality of non-homogeneous computing devices configured to host virtual machine instances, each computing device in the plurality of computing devices including a monitor operable to collect metadata about the associated computing device, the metadata describing a characteristic of the computing devices. The system also includes a registry operable to receive and store the metadata from the plurality of computing devices and a scheduler operable to define an availability zone within the plurality of computing devices based on the collected metadata, the availability zone including the computing devices within the plurality of computing devices that have the characteristic. The scheduler is further operable to select a host computing device out of the plurality of computing devices on which to instantiate a virtual machine instance based on whether the host computing device is within the availability zone.

In a further exemplary aspect, the present disclosure is directed to a method of efficiently utilizing a cloud computing system. The method includes collecting metadata associated with a plurality of computing devices with a plurality of monitors respectively associated with the plurality of computing devices, the plurality of computing devices being operable to host virtual machine instances. The method also includes storing the metadata from the plurality of computing devices in a registry and selecting a host computing device out of the plurality of computing devices on which to instantiate a virtual machine instance based on the metadata stored in the registry.

### DETAILED DESCRIPTION

The following disclosure has reference to computing services delivered on top of a cloud architecture.

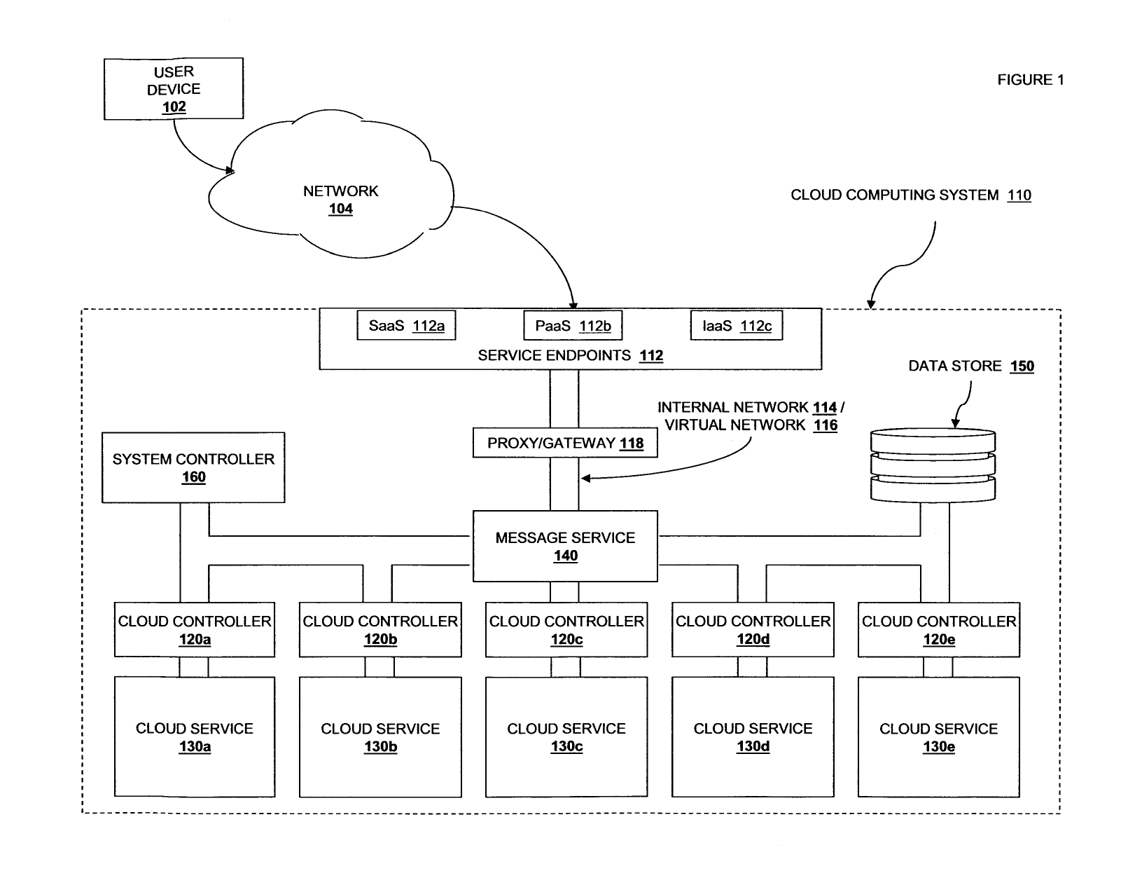

Referring now to FIG. 1, an external view of one embodiment of a cloud computing system 110 is illustrated. The cloud computing system 110 includes a user device 102 connected to a network 104 such as, for example, a Transport Control Protocol/Internet Protocol (TCP/IP) network (e.g., the Internet.) The user device 102 is coupled to the cloud computing system 110 via one or more service endpoints 112. Depending on the type of cloud service provided, these endpoints give varying amounts of control relative to the provisioning of resources within the cloud computing system 110. For example, SaaS endpoint 112a will typically only give information and access relative to the application running on the cloud storage system, and the scaling and processing aspects of the cloud computing system will be obscured from the user. PaaS endpoint 112b will typically give an abstract Application Programming Interface (API) that allows developers to declaratively request or command the backend storage, computation, and scaling resources provided by the cloud, without giving exact control to the user. IaaS endpoint 112c will typically provide the ability to directly request the provisioning of resources, such as computation units (typically virtual machines), software-defined or software-controlled network elements like routers, switches, domain name servers, etc., file or object storage facilities, authorization services, database services, queue services and endpoints, etc. In addition, users interacting with an IaaS cloud are typically able to provide virtual machine images that have been customized for user-specific functions. This allows the cloud computing system 110 to be used for new, user-defined services without requiring specific support.

It is important to recognize that the control allowed via an IaaS endpoint is not complete. Within the cloud computing system 110 are one or more cloud controllers 120 (running what is sometimes called a “cloud operating system”) that work on an even lower level, interacting with physical machines, managing the contradictory demands of the multi-tenant cloud computing system 110. The workings of the cloud controllers 120 are typically not exposed outside of the cloud computing system 110, even in an IaaS context. In one embodiment, the commands received through one of the service endpoints 112 are then routed via one or more internal networks 114. The internal network 114 couples the different services to each other. The internal network 114 may encompass various protocols or services, including but not limited to electrical, optical, or wireless connections at the physical layer; Ethernet, Fibre channel, ATM, and SONET at the MAC layer; TCP, UDP, ZeroMQ or other services at the connection layer; and XMPP, HTTP, AMPQ, STOMP, SMS, SMTP, SNMP, or other standards at the protocol layer. The internal network 114 is typically not exposed outside the cloud computing system, except to the extent that one or more virtual networks 116 may be exposed that control the internal routing according to various rules. The virtual networks 116 typically do not expose as much complexity as may exist in the actual internal network 114; but varying levels of granularity can be exposed to the control of the user, particularly in IaaS services.

In one or more embodiments, it may be useful to include various processing or routing nodes in the network layers 114 and 116, such as proxy/gateway 118. Other types of processing or routing nodes may include switches, routers, switch fabrics, caches, format modifiers, or correlators. These processing and routing nodes may or may not be visible to the outside. It is typical that one level of processing or routing nodes may be internal only, coupled to the internal network 114, whereas other types of network services may be defined by or accessible to users, and show up in one or more virtual networks 116. Either of the internal network 114 or the virtual networks 116 may be encrypted or authenticated according to the protocols and services described below.

In various embodiments, one or more parts of the cloud computing system 110 may be disposed on a single host. Accordingly, some of the “network” layers 114 and 116 may be composed of an internal call graph, inter-process communication (IPC), or a shared memory communication system.

Once a communication passes from the endpoints via a network layer 114 or 116, as well as possibly via one or more switches or processing devices 118, it is received by one or more applicable cloud controllers 120. The cloud controllers 120 are responsible for interpreting the message and coordinating the performance of the necessary corresponding services, returning a response if necessary. Although the cloud controllers 120 may provide services directly, more typically the cloud controllers 120 are in operative contact with the cloud services 130 necessary to provide the corresponding services. For example, it is possible for different services to be provided at different levels of abstraction. For example, a “compute” service 130a may work at an IaaS level, allowing the creation and control of user-defined virtual computing resources. In the same cloud computing system 110, a PaaS-level object storage service 130b may provide a declarative storage API, and a SaaS-level Queue service 130c, DNS service 130d, or Database service 130e may provide application services without exposing any of the underlying scaling or computational resources. Other services are contemplated as discussed in detail below.

In various embodiments, various cloud computing services or the cloud computing system itself may require a message passing system. The message routing service 140 is available to address this need, but it is not a required part of the system architecture in at least one embodiment. In one embodiment, the message routing service is used to transfer messages from one component to another without explicitly linking the state of the two components. Note that this message routing service 140 may or may not be available for user-addressable systems; in one preferred embodiment, there is a separation between storage for cloud service state and for user data, including user service state.

In various embodiments, various cloud computing services or the cloud computing system itself may require a persistent storage for system state. The data store 150 is available to address this need, but it is not a required part of the system architecture in at least one embodiment. In one embodiment, various aspects of system state are saved in redundant databases on various hosts or as special files in an object storage service. In a second embodiment, a relational database service is used to store system state. In a third embodiment, a column, graph, or document-oriented database is used. Note that this persistent storage may or may not be available for user-addressable systems; in one preferred embodiment, there is a separation between storage for cloud service state and for user data, including user service state.

In various embodiments, it may be useful for the cloud computing system 110 to have a system controller 160. In one embodiment, the system controller 160 is similar to the cloud computing controllers 120, except that it is used to control or direct operations at the level of the cloud computing system 110 rather than at the level of an individual service.

For clarity of discussion above, only one user device 102 has been illustrated as connected to the cloud computing system 110, and the discussion generally referred to receiving a communication from outside the cloud computing system, routing it to a cloud controller 120, and coordinating processing of the message via a service 130, the infrastructure described is also equally available for sending out messages. These messages may be sent out as replies to previous communications, or they may be internally sourced. Routing messages from a particular service 130 to a user device 102 is accomplished in the same manner as receiving a message from user device 102 to a service 130, just in reverse. The precise manner of receiving, processing, responding, and sending messages is described below with reference to the various discussed service embodiments. One of skill in the art will recognize, however, that a plurality of user devices 102 may, and typically will, be connected to the cloud computing system 110 and that each element or set of elements within the cloud computing system is replicable as necessary. Further, the cloud computing system 110, whether or not it has one endpoint or multiple endpoints, is expected to encompass embodiments including public clouds, private clouds, hybrid clouds, and multi-vendor clouds.

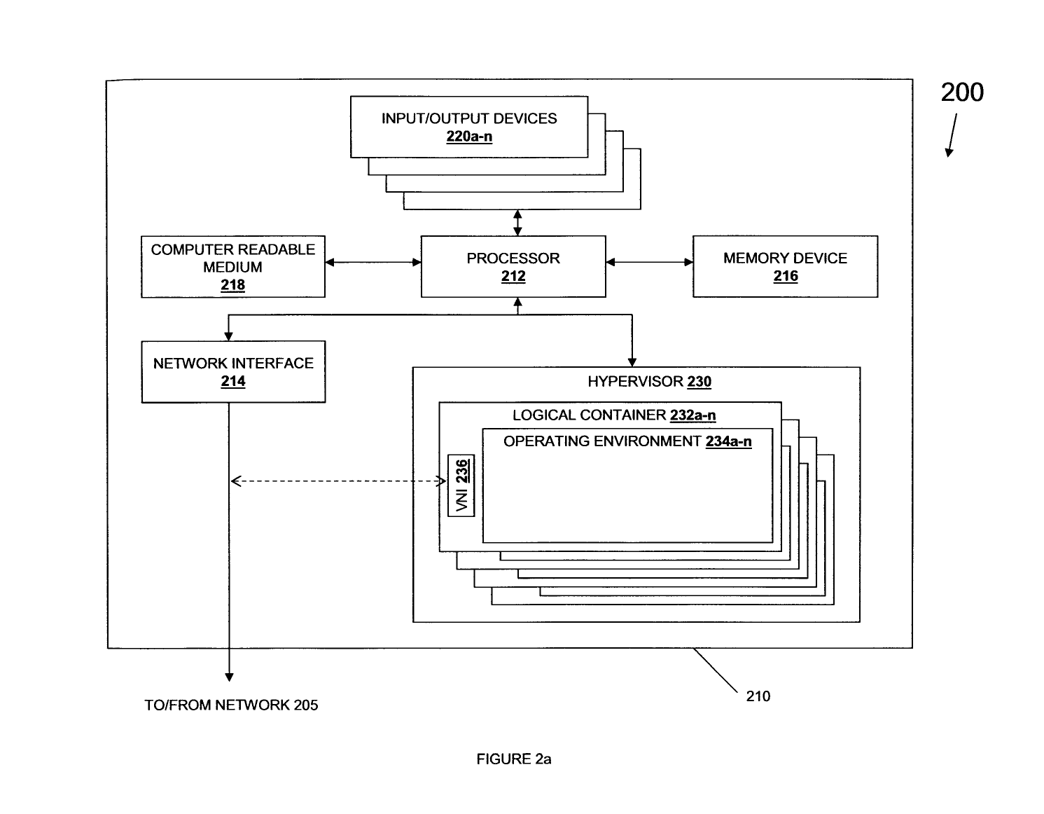

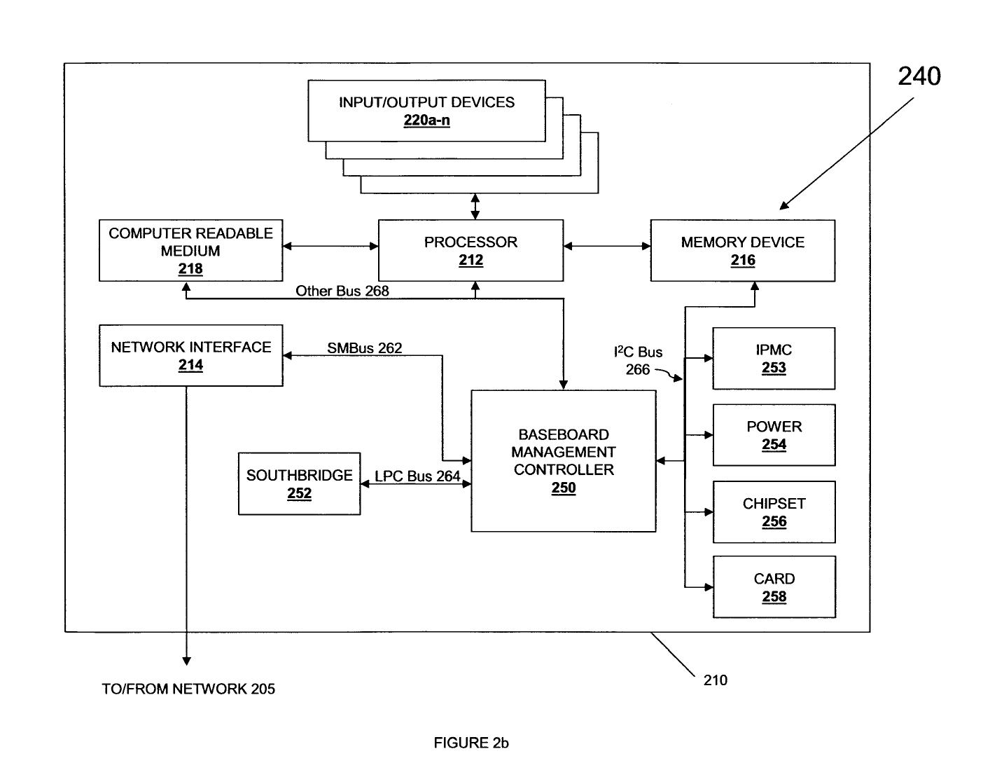

Each of the user device 102, the cloud computing system 110, the endpoints 112, the network switches and processing nodes 118, the cloud controllers 120 and the cloud services 130 typically include a respective information processing system, a subsystem, or a part of a subsystem for executing processes and performing operations (e.g., processing or communicating information). An information processing system is an electronic device capable of processing, executing or otherwise handling information, such as a computer. FIG. 2 shows an information processing system 210 that is representative of one of, or a portion of, the information processing systems described above.

Referring now to FIG. 2, diagram 200 shows an information processing system 210 configured to host one or more virtual machines, coupled to a network 205. The network 205 could be one or both of the networks 114 and 116 described above. An information processing system is an electronic device capable of processing, executing or otherwise handling information. Examples of information processing systems include a server computer, a personal computer (e.g., a desktop computer or a portable computer such as, for example, a laptop computer), a handheld computer, and/or a variety of other information handling systems known in the art. The information processing system 210 shown is representative of, one of, or a portion of, the information processing systems described above.

The information processing system 210 may include any or all of the following: (a) a processor 212 for executing and otherwise processing instructions, (b) one or more network interfaces 214 (e.g., circuitry) for communicating between the processor 212 and other devices, those other devices possibly located across the network 205; (c) a memory device 216 (e.g., FLASH memory, a random access memory (RAM) device or a read-only memory (ROM) device for storing information (e.g., instructions executed by processor 212 and data operated upon by processor 212 in response to such instructions)). In some embodiments, the information processing system 210 may also include a separate computer-readable medium 218 operably coupled to the processor 212 for storing information and instructions as described further below.

In one embodiment, there is more than one network interface 214, so that the multiple network interfaces can be used to separately route management, production, and other traffic. In one exemplary embodiment, an information processing system has a “management” interface at 1 GB/s, a “production” interface at 10 GB/s, and may have additional interfaces for channel bonding, high availability, or performance. An information processing device configured as a processing or routing node may also have an additional interface dedicated to public Internet traffic, and specific circuitry or resources necessary to act as a VLAN trunk.

In some embodiments, the information processing system 210 may include a plurality of input/output devices 220a-n which is operably coupled to the processor 212, for inputting or outputting information, such as a display device 220a, a print device 220b, or other electronic circuitry 220c-n for performing other operations of the information processing system 210 known in the art.

With reference to the computer-readable media, including both memory device 216 and secondary computer-readable medium 218, the computer-readable media and the processor 212 are structurally and functionally interrelated with one another as described below in further detail, and information processing system of the illustrative embodiment is structurally and functionally interrelated with a respective computer-readable medium similar to the manner in which the processor 212 is structurally and functionally interrelated with the computer-readable media 216 and 218. As discussed above, the computer-readable media may be implemented using a hard disk drive, a memory device, and/or a variety of other computer-readable media known in the art, and when including functional descriptive material, data structures are created that define structural and functional interrelationships between such data structures and the computer-readable media (and other aspects of the system 200). Such interrelationships permit the data structures' functionality to be realized. For example, in one embodiment the processor 212 reads (e.g., accesses or copies) such functional descriptive material from the network interface 214, the computer-readable media 218 onto the memory device 216 of the information processing system 210, and the information processing system 210 (more particularly, the processor 212) performs its operations, as described elsewhere herein, in response to such material stored in the memory device of the information processing system 210. In addition to reading such functional descriptive material from the computer-readable medium 218, the processor 212 is capable of reading such functional descriptive material from (or through) the network 105. In one embodiment, the information processing system 210 includes at least one type of computer-readable media that is non-transitory. For explanatory purposes below, singular forms such as “computer-readable medium,” “memory,” and “disk” are used, but it is intended that these may refer to all or any portion of the computer-readable media available in or to a particular information processing system 210, without limiting them to a specific location or implementation.

The information processing system 210 includes a hypervisor 230. The hypervisor 230 may be implemented in software, as a subsidiary information processing system, or in a tailored electrical circuit or as software instructions to be used in conjunction with a processor to create a hardware-software combination that implements the specific functionality described herein. To the extent that software is used to implement the hypervisor, it may include software that is stored on a computer-readable medium, including the computer-readable medium 218. The hypervisor may be included logically “below” a host operating system, as a host itself, as part of a larger host operating system, or as a program or process running “above” or “on top of” a host operating system. Examples of hypervisors include Xenserver, KVM, VMware, Microsoft's Hyper-V, and emulation programs such as QEMU.

The hypervisor 230 includes the functionality to add, remove, and modify a number of logical containers 232a-n associated with the hypervisor. Zero, one, or many of the logical containers 232a-n contain associated operating environments 234a-n. The logical containers 232a-n can implement various interfaces depending upon the desired characteristics of the operating environment. In one embodiment, a logical container 232 implements a hardware-like interface, such that the associated operating environment 234 appears to be running on or within an information processing system such as the information processing system 210. For example, one embodiment of a logical container 234 could implement an interface resembling an x86, x86-64, ARM, or other computer instruction set with appropriate RAM, busses, disks, and network devices. A corresponding operating environment 234 for this embodiment could be an operating system such as Microsoft Windows, Linux, Linux-Android, or Mac OS X. In another embodiment, a logical container 232 implements an operating system-like interface, such that the associated operating environment 234 appears to be running on or within an operating system. For example one embodiment of this type of logical container 232 could appear to be a Microsoft Windows, Linux, or Mac OS X operating system. Another possible operating system includes an Android operating system, which includes significant runtime functionality on top of a lower-level kernel. A corresponding operating environment 234 could enforce separation between users and processes such that each process or group of processes appeared to have sole access to the resources of the operating system. In a third environment, a logical container 232 implements a software-defined interface, such a language runtime or logical process that the associated operating environment 234 can use to run and interact with its environment. For example one embodiment of this type of logical container 232 could appear to be a Java, Dalvik, Lua, Python, or other language virtual machine. A corresponding operating environment 234 would use the built-in threading, processing, and code loading capabilities to load and run code. Adding, removing, or modifying a logical container 232 may or may not also involve adding, removing, or modifying an associated operating environment 234. For ease of explanation below, these operating environments will be described in terms of an embodiment as “Virtual Machines,” or “VMs,” but this is simply one implementation among the options listed above.

In one or more embodiments, a VM has one or more virtual network interfaces 236. How the virtual network interface is exposed to the operating environment depends upon the implementation of the operating environment. In an operating environment that mimics a hardware computer, the virtual network interface 236 appears as one or more virtual network interface cards. In an operating environment that appears as an operating system, the virtual network interface 236 appears as a virtual character device or socket. In an operating environment that appears as a language runtime, the virtual network interface appears as a socket, queue, message service, or other appropriate construct. The virtual network interfaces (VNIs) 236 may be associated with a virtual switch (Vswitch) at either the hypervisor or container level. The VNI 236 logically couples the operating environment 234 to the network, and allows the VMs to send and receive network traffic. In one embodiment, the physical network interface card 214 is also coupled to one or more VMs through a Vswitch.

In one or more embodiments, each VM includes identification data for use naming, interacting, or referring to the VM. This can include the Media Access Control (MAC) address, the Internet Protocol (IP) address, and one or more unambiguous names or identifiers.

In one or more embodiments, a “volume” is a detachable block storage device. In some embodiments, a particular volume can only be attached to one instance at a time, whereas in other embodiments a volume works like a Storage Area Network (SAN) so that it can be concurrently accessed by multiple devices. Volumes can be attached to either a particular information processing device or a particular virtual machine, so they are or appear to be local to that machine. Further, a volume attached to one information processing device or VM can be exported over the network to share access with other instances using common file sharing protocols. In other embodiments, there are areas of storage declared to be “local storage.” Typically a local storage volume will be storage from the information processing device shared with or exposed to one or more operating environments on the information processing device. Local storage is guaranteed to exist only for the duration of the operating environment; recreating the operating environment may or may not remove or erase any local storage associated with that operating environment.

In one embodiment, the information processing system 210 includes a number of hardware sensors implementing the Intelligent Platform Management Interface (IPMI) standard. IPMI is a message-based, hardware-level interface specification that operates independently of the hypervisor 230 and any logical containers 232 or operating environments 234.

The IPMI subsystem 240 includes one or more baseboard management controller (BMC) 250. In an embodiment that includes multiple management controllers, one BMC 250 is designated as the primary controller and the other controllers are designated as satellite controllers. The satellite controllers connect to the BMC via a system interface called Intelligent Platform Management Bus/Bridge (IPMB), which is a superset of an I²C (Inter-Integrated Circuit) bus such as I²C bus 266. The BMC 250 can also connect to satellite controllers via an Intelligent Platform Management Controller (IPMC) bus or bridge 253. The BMC 250 is managed with the Remote Management Control Protocol (RMCP) or RMCP+, or a similar protocol.

The IPMI subsystem 240 further includes other types of busses, including System Management (SMBus) 262, LPC bus 264, and other types of busses 268 as known in the art and provided by various system integrators for use with BMC 250. By use of these busses, the BMC can interact with or monitor different hardware subsystems within the information processing system 210, including the Southbridge 252, the network interface 214, the computer readable medium 218, the processor 212, the memory device 216, the power supply 254, the chipset 256 and the GPU or other card 258. In one embodiment, each of these subsystems has integrated testing and monitoring functionality, and exposes that directly to the BMC 250. In a second embodiment, there are one or more sensors arrayed on the motherboard or within the chassis of the information processing system 210 or a larger rack or computing enclosure. For example, SMART sensors are used in one embodiment to provide hard drive related information and heat sensors are used to provide temperature information for particular chips or parts of a chipset, fan and airspeed sensors are used to provide air movement and temperature information. Each part of the system can be connected to or instrumented by means of the IPMI subsystem 240, and the absence of an exemplary connection in FIG. 2b should not be considered limiting.

In one embodiment, the IPMI subsystem 240 is used to monitor the status and performance of the information processing system 210 by recording system temperatures, voltages, fans, power supplies and chassis information. In another embodiment, IPMI subsystem 240 is used to query inventory information and provide a hardware-based accounting of available functionality. In a third embodiment, IPMI subsystem 240 reviews hardware logs of out-of-range conditions and perform recovery procedures such as issuing requests from a remote console through the same connections. In a fourth embodiment, the IPMI subsystem provides an alerting mechanism for the system to send a simple network management protocol (SNMP) platform event trap (PET).

In one embodiment, the IPMI subsystem 240 also functions while hypervisor 230 is active. In this embodiment, the IPMI subsystem 240 exposes management data and structures to the system management software. In one implementation, the BMC 250 communicates via a direct out-of-band local area network or serial connection or via a side-band local area network connection to a remote client. In this embodiment, the side-band LAN connection utilizes the network interface 214. In a second embodiment, a dedicated network interface 214 is also provided. In a third embodiment, the BMC 250 communicates via serial over LAN, whereby serial console output can be received and interacted with via network 205. In other embodiments, the IPMI subsystem 240 also provides KVM (Keyboard-Video-Monitor switching) over IP, remote virtual media and an out-of-band embedded web server interface.

In a further embodiment, the IPMI subsystem 240 is extended with “virtual” sensors reporting on the performance of the various virtualized logical containers 232 supported by hypervisor 230. Although these are not strictly IPMI sensors because they are virtual and are not independent of the hypervisor 230 or the various logical containers 232 or operating environments 234, the use of a consistent management protocol for monitoring the usage of different parts of the system makes the extension of the IPMI subsystem worthwhile. In this embodiment, each logical container includes a virtual monitor that exposes IPMI information out via an IPMC connection to the BMC 250. In one embodiment, the virtual sensors are chosen to mimic their physical counterparts relative to the virtual “hardware” exposed within the logical container 232. In a second embodiment, the IPMI interface is extended with additional information that is gathered virtually and is only applicable to a virtual environment.

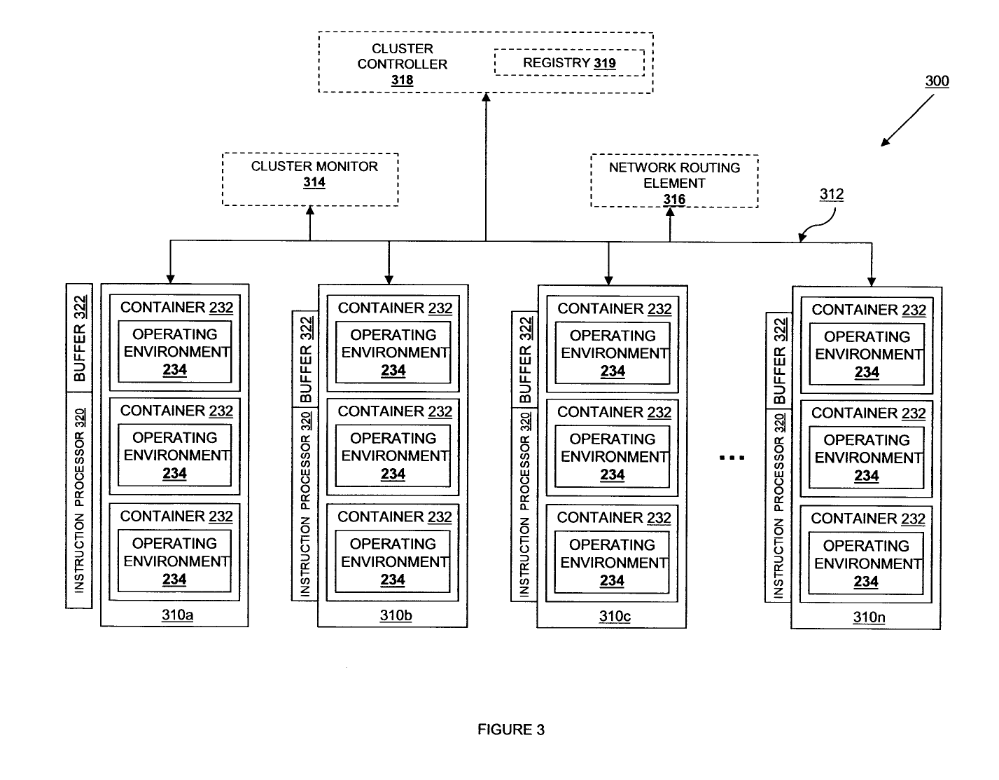

Turning now to FIG. 3, a simple network operating environment 300 for a cloud controller or cloud service is shown. The network operating environment 300 includes multiple information processing systems 310a-n, each of which correspond to a single information processing system 210 as described relative to FIG. 2, including a hypervisor 230, zero or more logical containers 232 and zero or more operating environments 234. The information processing systems 310a-n are connected via a communication medium 312, typically implemented using a known network protocol such as Ethernet, Fibre Channel, Infiniband, or IEEE 1394. For ease of explanation, the network operating environment 300 will be referred to as a “cluster,” “group,” or “zone” of operating environments. The cluster may also include a cluster monitor 314 and a network routing element 316. The cluster monitor 314 and network routing element 316 may be implemented as hardware, as software running on hardware, or may be implemented completely as software. In one implementation, one or both of the cluster monitor 314 or network routing element 316 is implemented in a logical container 232 using an operating environment 234 as described above. In another embodiment, one or both of the cluster monitor 314 or network routing element 316 is implemented so that the cluster corresponds to a group of physically co-located information processing systems, such as in a rack, row, or group of physical machines.

The cluster monitor 314 provides an interface to the cluster in general, and provides a single point of contact allowing someone outside the system to query and control any one of the information processing systems 310, the logical containers 232 and the operating environments 234. In one embodiment, the cluster monitor also provides monitoring and reporting capabilities.

The network routing element 316 allows the information processing systems 310, the logical containers 232 and the operating environments 234 to be connected together in a network topology. The illustrated tree topology is only one possible topology; the information processing systems and operating environments can be logically arrayed in a ring, in a star, in a graph, or in multiple logical arrangements through the use of vLANs.

In one embodiment, the cluster also includes a cluster controller 318. The cluster controller is outside the cluster, and is used to store or provide identifying information associated with the different addressable elements in the cluster—specifically the cluster generally (addressable as the cluster monitor 314), the cluster network router (addressable as the network routing element 316), each information processing system 310, and with each information processing system the associated logical containers 232 and operating environments 234.

The cluster controller 318 is outside the cluster, and is used to store or provide identifying information associated with the different addressable elements in the cluster—specifically the cluster generally (addressable as the cluster monitor 314), the cluster network router (addressable as the network routing element 316), each information processing system 310, and with each information processing system the associated logical containers 232 and operating environments 234. In one embodiment, the cluster controller 318 includes a registry of VM information 319. In a second embodiment, the registry 319 is associated with but not included in the cluster controller 318.

In one embodiment, the cluster also includes one or more instruction processors 320. In the embodiment shown, the instruction processor is located in the hypervisor, but it is also contemplated to locate an instruction processor within an active VM or at a cluster level, for example in a piece of machinery associated with a rack or cluster. In one embodiment, the instruction processor 320 is implemented in a tailored electrical circuit or as software instructions to be used in conjunction with a physical or virtual processor to create a hardware-software combination that implements the specific functionality described herein. To the extent that one embodiment includes computer-executable instructions, those instructions may include software that is stored on a computer-readable medium. Further, one or more embodiments have associated with them a buffer 322. The buffer 322 can take the form of data structures, a memory, a computer-readable medium, or an off-script-processor facility. For example, one embodiment uses a language runtime as an instruction processor 320. The language runtime can be run directly on top of the hypervisor, as a process in an active operating environment, or can be run from a low-power embedded processor. In a second embodiment, the instruction processor 320 takes the form of a series of interoperating but discrete components, some or all of which may be implemented as software programs. For example, in this embodiment, an interoperating bash shell, gzip program, an rsync program, and a cryptographic accelerator chip are all components that may be used in an instruction processor 320. In another embodiment, the instruction processor 320 is a discrete component, using a small amount of flash and a low power processor, such as a low-power ARM processor. This hardware-based instruction processor can be embedded on a network interface card, built into the hardware of a rack, or provided as an add-on to the physical chips associated with an information processing system 310. It is expected that in many embodiments, the instruction processor 320 will have an integrated battery and will be able to spend an extended period of time without drawing current. Various embodiments also contemplate the use of an embedded Linux or Linux-Android environment.

Networking

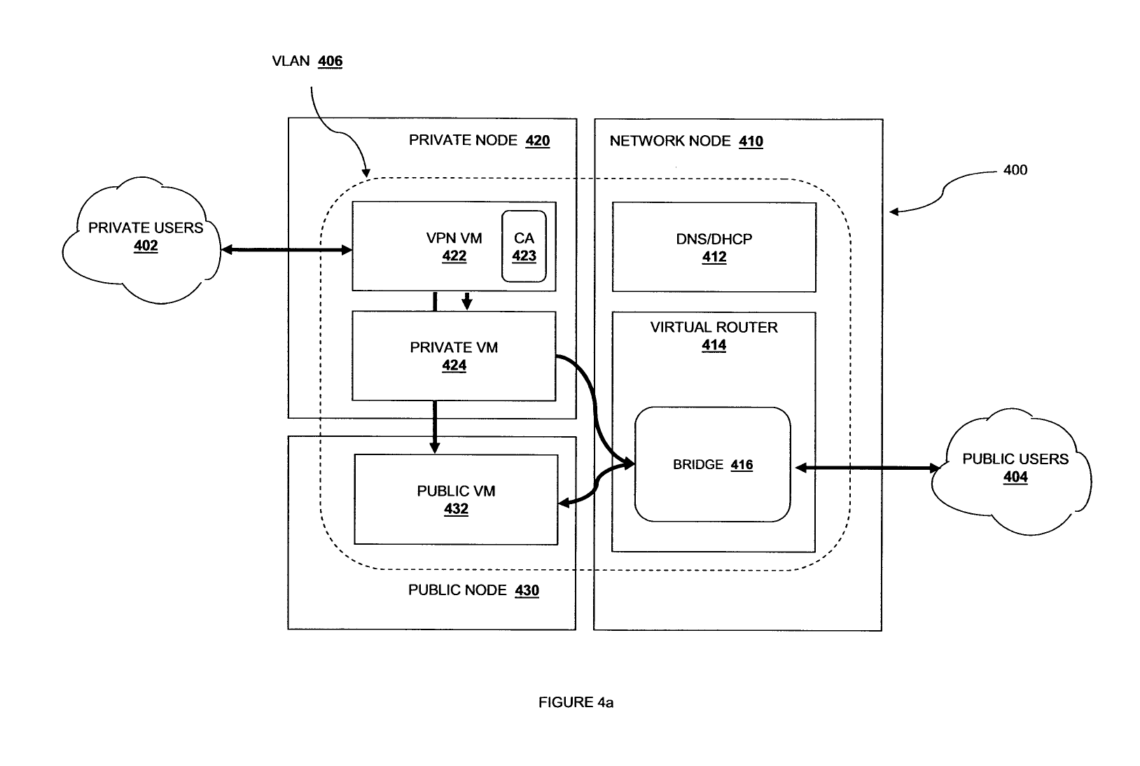

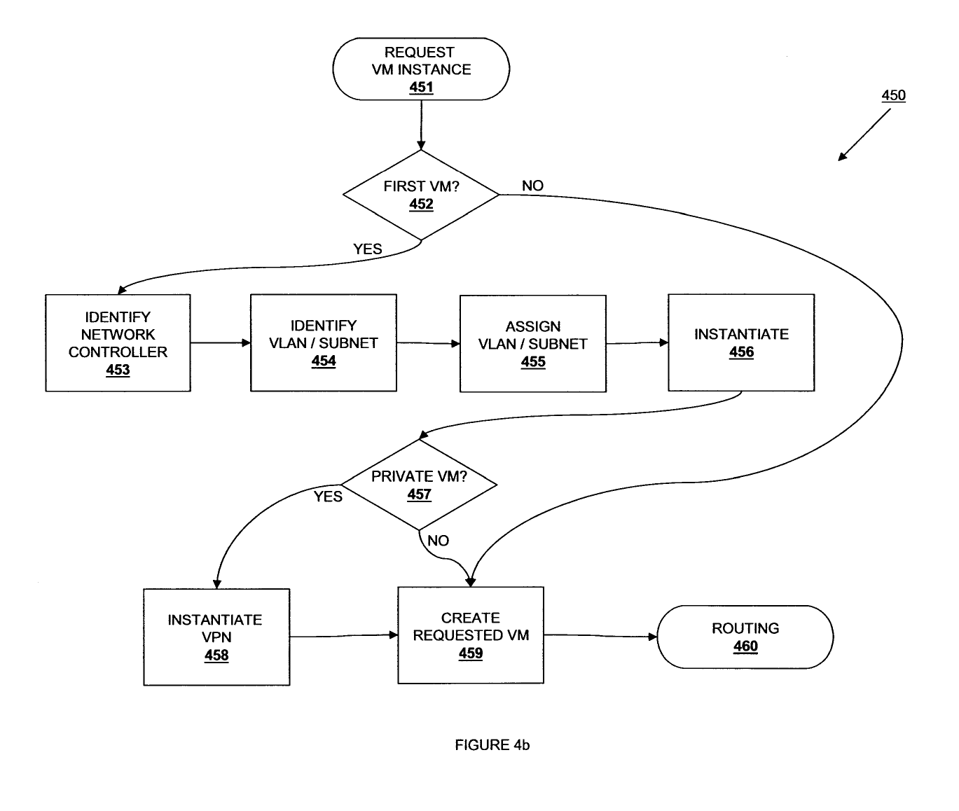

Referring now to FIG. 4a, a diagram of the network connections available to one embodiment of the system is shown. The network 400 is one embodiment of a virtual network 116 as discussed relative to FIG. 1, and is implemented on top of the internal network layer 114. A particular node is connected to the virtual network 400 through a virtual network interface 236 operating through physical network interface 214. The VLANs, VSwitches, VPNs, and other pieces of network hardware (real or virtual) are may be network routing elements 316 or may serve another function in the communications medium 312.

In one embodiment, the cloud computing system 110 uses both “fixed” IPs and “floating” IPs to address virtual machines. Fixed IPs are assigned to an instance on creation and stay the same until the instance is explicitly terminated. Floating IPs are IP addresses that can be dynamically associated with an instance. A floating IP address can be disassociated and associated with another instance at any time.

Different embodiments include various strategies for implementing and allocating fixed IPs, including “flat” mode, a “flat DHCP” mode, and a “VLAN DHCP” mode.

In one embodiment, fixed IP addresses are managed using a flat Mode. In this embodiment, an instance receives a fixed IP from a pool of available IP addresses. All instances are attached to the same bridge by default. Other networking configuration instructions are placed into the instance before it is booted or on boot.

In another embodiment, fixed IP addresses are managed using a flat DHCP mode. Flat DHCP mode is similar to the flat mode, in that all instances are attached to the same bridge. Instances will attempt to bridge using the default Ethernet device or socket. Instead of allocation from a fixed pool, a DHCP server listens on the bridge and instances receive their fixed IPs by doing a dhcpdiscover.

Turning now to a preferred embodiment using VLAN DHCP mode, there are two groups of off-local-network users, the private users 402 and the public internet users 404. To respond to communications from the private users 402 and the public users 404, the network 400 includes three nodes, network node 410, private node 420, and public node 430. The nodes include one or more virtual machines or virtual devices, such as DNS/DHCP server 412 and virtual router 414 on network node 410, VPN 422 and private VM 424 on private node 420, and public VM 432 on public node 430.

In one embodiment, VLAN DHCP mode requires a switch that supports host-managed VLAN tagging. In one embodiment, there is a VLAN 406 and bridge 416 for each project or group. In the illustrated embodiment, there is a VLAN associated with a particular project. The project receives a range of private IP addresses that are only accessible from inside the VLAN. and assigns an IP address from this range to private node 420, as well as to a VNI in the virtual devices in the VLAN. In one embodiment, DHCP server 412 is running on a VM that receives a static VLAN IP address at a known address, and virtual router VM 414, VPN VM 422, private VM 424, and public VM 432 all receive private IP addresses upon request to the DHCP server running on the DHCP server VM. In addition, the DHCP server provides a public IP address to the virtual router VM 414 and optionally to the public VM 432. In a second embodiment, the DHCP server 412 is running on or available from the virtual router VM 414, and the public IP address of the virtual router VM 414 is used as the DHCP address.

In an embodiment using VLAN DHCP mode, there is a private network segment for each project's or group's instances that can be accessed via a dedicated VPN connection from the Internet. As described below, each VLAN project or group gets its own VLAN, network bridge, and subnet. In one embodiment, subnets are specified by the network administrator, and assigned dynamically to a project or group when required. A DHCP Server is started for each VLAN to pass out IP addresses to VM instances from the assigned subnet. All instances belonging to the VLAN project or group are bridged into the same VLAN. In this fashion, network traffic between VM instances belonging to the same VLAN is always open but the system can enforce isolation of network traffic between different projects by enforcing one VLAN per project.

As shown in FIG. 4a, VLAN DHCP mode includes provisions for both private and public access. For private access (shown by the arrows to and from the private users cloud 402), users create an access keypair (as described further below) for access to the virtual private network through the gateway VPN VM 422. From the VPN VM 422, both the private VM 424 and the public VM 432 are accessible via the private IP addresses valid on the VLAN.

Public access is shown by the arrows to and from the public users cloud 404. Communications that come in from the public users cloud arrive at the virtual router VM 414 and are subject to network address translation (NAT) to access the public virtual machine via the bridge 416. Communications out from the private VM 424 are source NATted by the bridge 416 so that the external source appears to be the virtual router VM 414. If the public VM 432 does not have an externally routable address, communications out from the public VM 432 may be source NATted as well.

In one embodiment of VLAN DHCP mode, the second IP in each private network is reserved for the VPN VM instance 422. This gives a consistent IP to the instance so that forwarding rules can be more easily created. The network for each project is given a specific high-numbered port on the public IP of the network node 410. This port is automatically forwarded to the appropriate VPN port on the VPN VM 422.

In one embodiment, each group or project has its own certificate authority (CA) 423. The CA 423 is used to sign the certificate for the VPN VM 422, and is also passed to users on the private users cloud 402. When a certificate is revoked, a new Certificate Revocation List (CRL) is generated. The VPN VM 422 will block revoked users from connecting to the VPN if they attempt to connect using a revoked certificate.

In a project VLAN organized similarly to the embodiment described above, the project has an independent RFC 1918 IP space; public IP via NAT; has no default inbound network access without public NAT; has limited, controllable outbound network access; limited, controllable access to other project segments; and VPN access to instance and cloud APIs. Further, there is a DMZ segment for support services, allowing project metadata and reporting to be provided in a secure manner.

In one embodiment, VLANs are segregated using 802.1q VLAN tagging in the switching layer, but other tagging schemes such as 802.1 ad, MPLS, or frame tagging are also contemplated. Network hosts create VLAN-specific interfaces and bridges as required.

In one embodiment, private VM 424 has per-VLAN interfaces and bridges created as required. These do not have IP addresses in the host to protect host access. Access is provided via routing table entries created per project and instance to protect against IP/MAC address spoofing and ARP poisoning.

FIG. 4b is a flowchart showing the establishment of a VLAN for a project according to one embodiment. The process 450 starts at step 451, when a VM instance for the project is requested. When running a VM instance, a user needs to specify a project for the instances, and the applicable security rules and security groups (as described herein) that the instance should join. At step 452, a cloud controller determines if this is the first instance to be created for the project. If this is the first, then the process proceeds to step 453. If the project already exists, then the process moves to step 459. At step 453, a network controller is identified to act as the network host for the project. This may involve creating a virtual network device and assigning it the role of network controller. In one embodiment, this is a virtual router VM 414. At step 454, an unused VLAN id and unused subnet are identified. At step 455, the VLAN id and subnet are assigned to the project. At step 456, DHCP server 412 and bridge 416 are instantiated and registered. At step 457, the VM instance request is examined to see if the request is for a private VM 424 or public VM 432. If the request is for a private VM, the process moves to step 458. Otherwise, the process moves to step 460. At step 458, the VPN VM 422 is instantiated and allocated the second IP in the assigned subnet. At step 459, the subnet and a VLAN have already been assigned to the project. Accordingly, the requested VM is created and assigned and assigned a private IP within the project's subnet. At step 460, the routing rules in bridge 416 are updated to properly NAT traffic to or from the requested VM.

Message Service

Between the various virtual machines and virtual devices, it may be necessary to have a reliable messaging infrastructure. In various embodiments, a message queuing service is used for both local and remote communication so that there is no requirement that any of the services exist on the same physical machine. Various existing messaging infrastructures are contemplated, including AMQP, ZeroMQ, STOMP and XMPP. Note that this messaging system may or may not be available for user-addressable systems; in one preferred embodiment, there is a separation between internal messaging services and any messaging services associated with user data.

In one embodiment, the message service sits between various components and allows them to communicate in a loosely coupled fashion. This can be accomplished using Remote Procedure Calls (RPC hereinafter) to communicate between components, built atop either direct messages and/or an underlying publish/subscribe infrastructure. In a typical embodiment, it is expected that both direct and topic-based exchanges are used. This allows for decoupling of the components, full asynchronous communications, and transparent balancing between equivalent components. In some embodiments, calls between different APIs can be supported over the distributed system by providing an adapter class which takes care of marshalling and unmarshalling of messages into function calls.

In one embodiment, a cloud controller 120 (or the applicable cloud service 130) creates two queues at initialization time, one that accepts node-specific messages and another that accepts generic messages addressed to any node of a particular type. This allows both specific node control as well as orchestration of the cloud service without limiting the particular implementation of a node. In an embodiment in which these message queues are bridged to an API, the API can act as a consumer, server, or publisher.

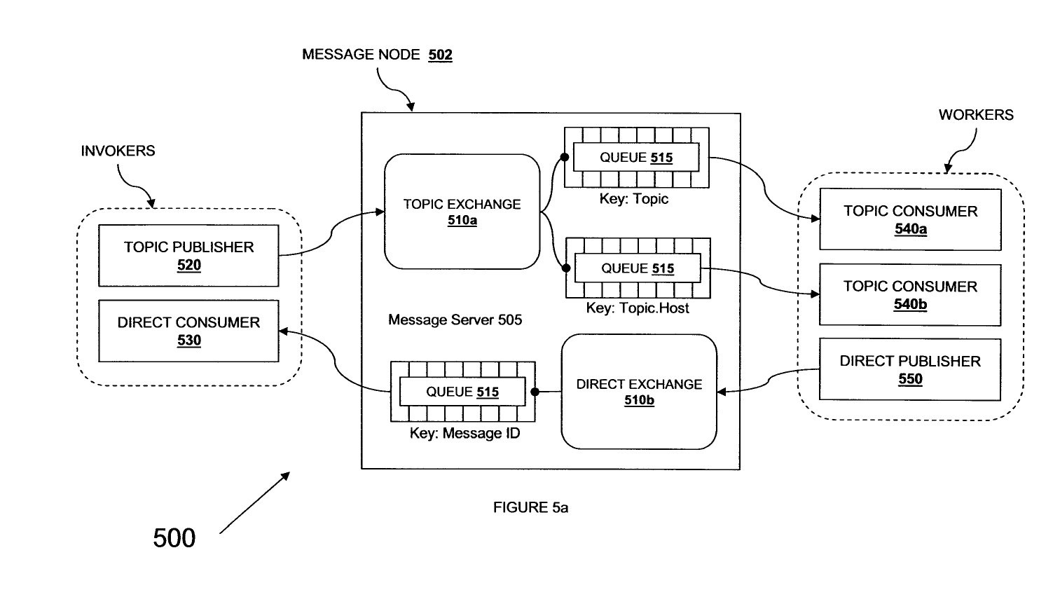

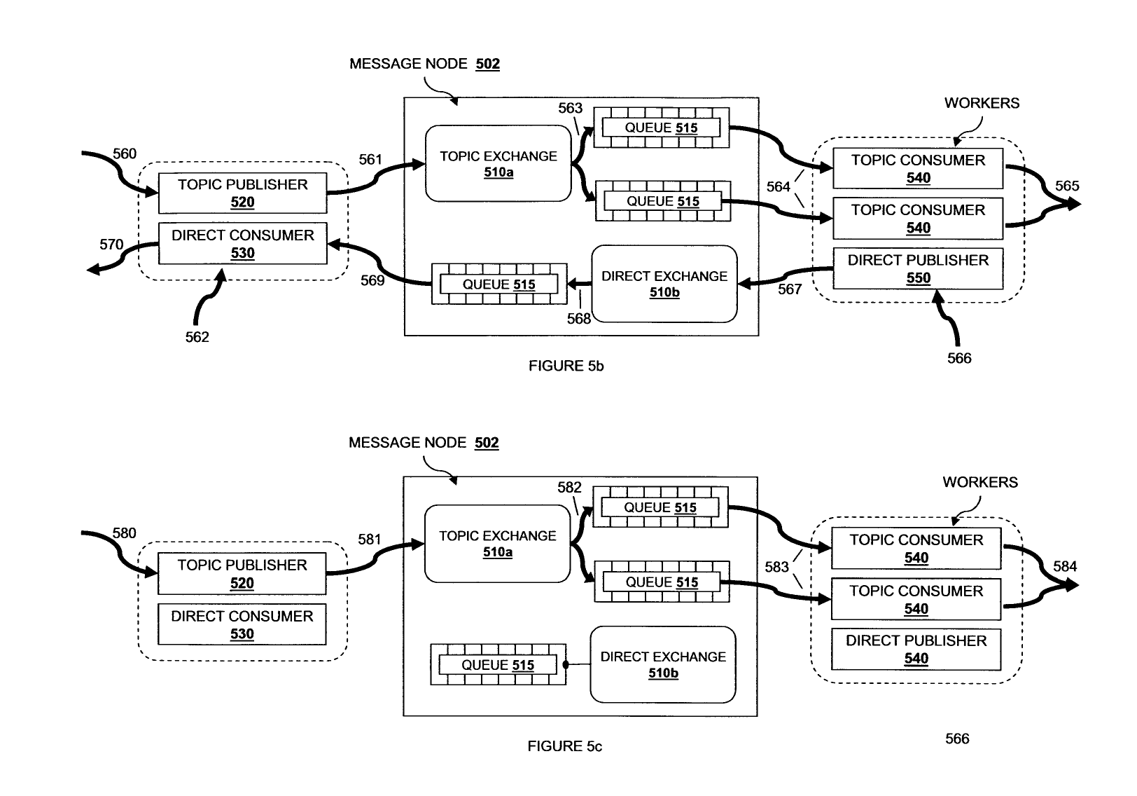

Turning now to FIG. 5a, one implementation of a message service 140 is shown at reference number 500. For simplicity of description, FIG. 5a shows the message service 500 when a single instance 502 is deployed and shared in the cloud computing system 110, but the message service 500 can be either centralized or fully distributed.

In one embodiment, the message service 500 keeps traffic associated with different queues or routing keys separate, so that disparate services can use the message service without interfering with each other. Accordingly, the message queue service may be used to communicate messages between network elements, between cloud services 130, between cloud controllers 120, between network elements, or between any group of sub-elements within the above. More than one message service 500 may be used, and a cloud service 130 may use its own message service as required.

For clarity of exposition, access to the message service 500 will be described in terms of “Invokers” and “Workers,” but these labels are purely expository and are not intended to convey a limitation on purpose; in some embodiments, a single component (such as a VM) may act first as an Invoker, then as a Worker, the other way around, or simultaneously in each role. An Invoker is a component that sends messages in the system via two operations: 1) an RPC (Remote Procedure Call) directed message and ii) an RPC broadcast. A Worker is a component that receives messages from the message system and replies accordingly.

In one embodiment, there is a message server 505 including one or more exchanges 510. In a second embodiment, the message system is “brokerless,” and one or more exchanges are located at each client. The exchanges 510 act as internal message routing elements so that components interacting with the message service 500 can send and receive messages. In one embodiment, these exchanges are subdivided further into a topic exchange 510a and a direct exchange 510b. An exchange 510 is a routing structure or system that exists in a particular context. In a currently preferred embodiment, multiple contexts can be included within a single message service with each one acting independently of the others. In one embodiment, the type of exchange, such as a topic exchange 510a vs. direct exchange 510b determines the routing policy. In a second embodiment, the routing policy is determined via a series of routing rules evaluated by the exchange 510.

The direct exchange 510b is a routing element created during or for RPC directed message operations. In one embodiment, there are many instances of a direct exchange 510b that are created as needed for the message service 500. In a further embodiment, there is one direct exchange 510b created for each RPC directed message received by the system.

The topic exchange 510a is a routing element created during or for RPC directed broadcast operations. In one simple embodiment, every message received by the topic exchange is received by every other connected component. In a second embodiment, the routing rule within a topic exchange is described as publish-subscribe, wherein different components can specify a discriminating function and only topics matching the discriminator are passed along. In one embodiment, there are many instances of a topic exchange 510a that are created as needed for the message service 500. In one embodiment, there is one topic-based exchange for every topic created in the cloud computing system. In a second embodiment, there are a set number of topics that have pre-created and persistent topic exchanges 510a.

Within one or more of the exchanges 510, it may be useful to have a queue element 515. A queue 515 is a message stream; messages sent into the stream are kept in the queue 515 until a consuming component connects to the queue and fetches the message. A queue 515 can be shared or can be exclusive. In one embodiment, queues with the same topic are shared amongst Workers subscribed to that topic.

In a typical embodiment, a queue 515 will implement a FIFO policy for messages and ensure that they are delivered in the same order that they are received. In other embodiments, however, a queue 515 may implement other policies, such as LIFO, a priority queue (highest-priority messages are delivered first), or age (oldest objects in the queue are delivered first), or other configurable delivery policies. In other embodiments, a queue 515 may or may not make any guarantees related to message delivery or message persistence.

In one embodiment, element 520 is a topic publisher. A topic publisher 520 is created, instantiated, or awakened when an RPC directed message or an RPC broadcast operation is executed; this object is instantiated and used to push a message to the message system. Every publisher connects always to the same topic-based exchange; its life-cycle is limited to the message delivery.

In one embodiment, element 530 is a direct consumer. A direct consumer 530 is created, instantiated, or awakened if an RPC directed message operation is executed; this component is instantiated and used to receive a response message from the queuing system. Every direct consumer 530 connects to a unique direct-based exchange via a unique exclusive queue, identified by a UUID or other unique name. The life-cycle of the direct consumer 530 is limited to the message delivery. In one embodiment, the exchange and queue identifiers are included the message sent by the topic publisher 520 for RPC directed message operations.

In one embodiment, elements 540 (elements 540a and 540b) are topic consumers. In one embodiment, a topic consumer 540 is created, instantiated, or awakened at system start. In a second embodiment, a topic consumer 540 is created, instantiated, or awakened when a topic is registered with the message system 500. In a third embodiment, a topic consumer 540 is created, instantiated, or awakened at the same time that a Worker or Workers are instantiated and persists as long as the associated Worker or Workers have not been destroyed. In this embodiment, the topic consumer 540 is used to receive messages from the queue and it invokes the appropriate action as defined by the Worker role. A topic consumer 540 connects to the topic-based exchange either via a shared queue or via a unique exclusive queue. In one embodiment, every Worker has two associated topic consumers 540, one that is addressed only during an RPC broadcast operations (and it connects to a shared queue whose exchange key is defined by the topic) and the other that is addressed only during an RPC directed message operations, connected to a unique queue whose with the exchange key is defined by the topic and the host.

In one embodiment, element 550 is a direct publisher. In one embodiment, a direct publisher 550 is created, instantiated, or awakened for RPC directed message operations and it is instantiated to return the message required by the request/response operation. The object connects to a direct-based exchange whose identity is dictated by the incoming message.

Turning now to FIG. 5b, one embodiment of the process of sending an RPC directed message is shown relative to the elements of the message system 500 as described relative to FIG. 5a. All elements are as described above relative to FIG. 5a unless described otherwise. At step 560, a topic publisher 520 is instantiated. At step 561, the topic publisher 520 sends a message to an exchange 510a. At step 562, a direct consumer 530 is instantiated to wait for the response message. At step 563, the message is dispatched by the exchange 510a. At step 564, the message is fetched by the topic consumer 540 dictated by the routing key (either by topic or by topic and host). At step 565, the message is passed to a Worker associated with the topic consumer 540. If needed, at step 566, a direct publisher 550 is instantiated to send a response message via the message system 500. At step 567, the direct publisher 540 sends a message to an exchange 510b. At step 568, the response message is dispatched by the exchange 510b. At step 569, the response message is fetched by the direct consumer 530 instantiated to receive the response and dictated by the routing key. At step 570, the message response is passed to the Invoker.

Turning now to FIG. 5c, one embodiment of the process of sending an RPC broadcast message is shown relative to the elements of the message system 500 as described relative to FIG. 5a. All elements are as described above relative to FIG. 5a unless described otherwise. At step 580, a topic publisher 520 is instantiated. At step 581, the topic publisher 520 sends a message to an exchange 510a. At step 582, the message is dispatched by the exchange 510a. At step 583, the message is fetched by a topic consumer 540 dictated by the routing key (either by topic or by topic and host). At step 584, the message is passed to a Worker associated with the topic consumer 540.

In some embodiments, a response to an RPC broadcast message can be requested. In that case, the process follows the steps outlined relative to FIG. 5b to return a response to the Invoker.

Rule Engine

Because many aspects of the cloud computing system do not allow direct access to the underlying hardware or services, many aspects of the cloud computing system are handled declaratively, through rule-based computing. Rule-based computing organizes statements into a data model that can be used for deduction, rewriting, and other inferential or transformational tasks. The data model can then be used to represent some problem domain and reason about the objects in that domain and the relations between them. In one embodiment, one or more controllers or services have an associated rule processor that performs rule-based deduction, inference, and reasoning.

Rule Engines can be implemented similarly to instruction processors as described relative to FIG. 3, and may be implemented as a sub-module of a instruction processor where needed. In other embodiments, Rule Engines can be implemented as discrete components, for example as a tailored electrical circuit or as software instructions to be used in conjunction with a hardware processor to create a hardware-software combination that implements the specific functionality described herein. To the extent that one embodiment includes computer-executable instructions, those instructions may include software that is stored on a computer-readable medium. Further, one or more embodiments have associated with them a buffer. The buffer can take the form of data structures, a memory, a computer-readable medium, or an off-rule-engine facility. For example, one embodiment uses a language runtime as a rule engine, running as a discrete operating environment, as a process in an active operating environment, or can be run from a low-power embedded processor. In a second embodiment, the rule engine takes the form of a series of interoperating but discrete components, some or all of which may be implemented as software programs. In another embodiment, the rule engine is a discrete component, using a small amount of flash and a low power processor, such as a low-power ARM processor.

Security and Access Control

One subset of rule-based systems is role-based computing systems. A role-based computing system is a system in which identities and resources are managed by aggregating them into “roles” based on job functions, physical location, legal controls, and other criteria. These roles can be used to model organizational structures, manage assets, or organize data. By arranging roles and the associated rules into graphs or hierarchies, these roles can be used to reason about and manage various resources.

In one application, role-based strategies have been used to form a security model called Role-Based Access Control (RBAC). RBAC associates special rules, called “permissions,” with roles; each role is granted only the minimum permissions necessary for the performance of the functions associated with that role. Identities are assigned to roles, giving the users and other entities the permissions necessary to accomplish job functions. RBAC has been formalized mathematically by NIST and accepted as a standard by ANSI. American National Standard 359-2004 is the information technology industry consensus standard for RBAC, and is incorporated herein by reference in its entirety.

Because the cloud computing systems are designed to be multi-tenant, it is necessary to include limits and security in the basic architecture of the system. In one preferred embodiment, this is done through rules declaring the existence of users, resources, projects, and groups. Rule-based access controls govern the use and interactions of these logical entities.

In a preferred embodiment, a user is defined as an entity that will act in one or more roles. A user is typically associated with an internal or external entity that will interact with the cloud computing system in some respect. A user can have multiple roles simultaneously. In one embodiment of the system, a user's roles define which API commands that user can perform.

In a preferred embodiment, a resource is defined as some object to which access is restricted. In various embodiments, resources can include network or user access to a virtual machine or virtual device, the ability to use the computational abilities of a device, access to storage, an amount of storage, API access, ability to configure a network, ability to access a network, network bandwidth, network speed, network latency, ability to access or set authentication rules, ability to access or set rules regarding resources, etc. In general, any item which may be restricted or metered is modeled as a resource.

In one embodiment, resources may have quotas associated with them. A quota is a rule limiting the use or access to a resource. A quota can be placed on a per-project level, a per-role level, a per-user level, or a per-group level. In one embodiment, quotas can be applied to the number of volumes which can be created, the total size of all volumes within a project or group, the number of instances which can be launched, both total and per instance type, the number of processor cores which can be allocated, and publicly accessible IP addresses. Other restrictions are also contemplated as described herein.

In a preferred embodiment, a project is defined as a flexible association of users, acting in certain roles, with defined access to various resources. A project is typically defined by an administrative user according to varying demands. There may be templates for certain types of projects, but a project is a logical grouping created for administrative purposes and may or may not bear a necessary relation to anything outside the project. In a preferred embodiment, arbitrary roles can be defined relating to one or more particular projects only.

In a preferred embodiment, a group is defined as a logical association of some other defined entity. There may be groups of users, groups of resources, groups of projects, groups of quotas, or groups which contain multiple different types of defined entities. For example, in one embodiment, a group “development” is defined. The development group may include a group of users with the tag “developers” and a group of virtual machine resources (“developer machines”). These may be connected to a developer-only virtual network (“devnet”). The development group may have a number of ongoing development projects, each with an associated “manager” role. There may be per-user quotas on storage and a group-wide quota on the total monthly bill associated with all development resources.

The applicable set of rules, roles, and quotas is based upon context. In one embodiment, there are global roles, user-specific roles, project-specific roles, and group-specific roles. In one embodiment, a user's actual permissions in a particular project are the intersection of the global roles, user-specific roles, project-specific roles, and group-specific roles associated with that user, as well as any rules associated with project or group resources possibly affected by the user.

In one preferred embodiment, authentication of a user is performed through public/private encryption, with keys used to authenticate particular users, or in some cases, particular resources such as particular machines. A user or machine may have multiple keypairs associated with different roles, projects, groups, or permissions. For example, a different key may be needed for general authentication and for project access. In one such embodiment, a user is identified within the system by the possession and use of one or more cryptographic keys, such as an access and secret key. A user's access key needs to be included in a request, and the request must be signed with the secret key. Upon receipt of API requests, the rules engine verifies the signature and executes commands on behalf of the user.

Some resources, such as virtual machine images, can be shared by many users. Accordingly, it can be impractical or insecure to include private cryptographic information in association with a shared resource. In one embodiment, the system supports providing public keys to resources dynamically. In one exemplary embodiment, a public key, such as an SSH key, is injected into a VM instance before it is booted. This allows a user to login to the instances securely, without sharing private key information and compromising security. Other shared resources that require per-instance authentication are handled similarly.

In one embodiment, a rule processor is also used to attach and evaluate rule-based restrictions on non-user entities within the system. In this embodiment, a “Cloud Security Group” (or just “security group”) is a named collection of access rules that apply to one or more non-user entities. Typically these will include network access rules, such as firewall policies, applicable to a resource, but the rules may apply to any resource, project, or group. For example, in one embodiment a security group specifies which incoming network traffic should be delivered to all VM instances in the group, all other incoming traffic being discarded. Users with the appropriate permissions (as defined by their roles) can modify rules for a group. New rules are automatically enforced for all running instances and instances launched from then on.

When launching VM instances, a project or group administrator specifies which security groups it wants the VM to join. If the directive to join the groups has been given by an administrator with sufficient permissions, newly launched VMs will become a member of the specified security groups when they are launched. In one embodiment, an instance is assigned to a “default” group if no groups are specified. In a further embodiment, the default group allows all network traffic from other members of this group and discards traffic from other IP addresses and groups. The rules associated with the default group can be modified by users with roles having the appropriate permissions.

In some embodiments, a security group is similar to a role for a non-user, extending RBAC to projects, groups, and resources. For example, one rule in a security group can stipulate that servers with the “webapp” role must be able to connect to servers with the “database” role on port 3306. In some embodiments, an instance can be launched with membership of multiple security groups—similar to a server with multiple roles. Security groups are not necessarily limited, and can be equally expressive as any other type of RBAC security. In one preferred embodiment, all rules in security groups are ACCEPT rules, making them easily composable.

In one embodiment, each rule in a security group must specify the source of packets to be allowed. This can be specified using CIDR notation (such as 10.22.0.0/16, representing a private subnet in the 10.22 IP space, or 0.0.0.0/0 representing the entire Internet) or another security group. The creation of rules with other security groups specified as sources helps deal with the elastic nature of cloud computing; instances are impermanent and IP addresses frequently change. In this embodiment, security groups can be maintained dynamically without having to adjust actual IP addresses.

In one embodiment, the APIs, RBAC-based authentication system, and various specific roles are used to provide a US eAuthentication-compatible federated authentication system to achieve access controls and limits based on traditional operational roles. In a further embodiment, the implementation of auditing APIs provides the necessary environment to receive a certification under FIPS 199 Moderate classification for a hybrid cloud environment.

Typical implementations of US eAuthentication-compatible systems are structured as a Federated LDAP user store, back-ending to a SAML Policy Controller. The SAML Policy Controller maps access requests or access paths, such as requests to particular URLs, to a Policy Agent in front of an eAuth-secured application. In a preferred embodiment, the application-specific account information is stored either in extended schema on the LDAP server itself, via the use of a translucent LDAP proxy, or in an independent datastore keyed off of the UID provided via SAML assertion.

As described above, in one embodiment API calls are secured via access and secret keys, which are used to sign API calls, along with traditional timestamps to prevent replay attacks. The APIs can be logically grouped into sets that align with the following typical roles:
Base User
System Administrator
Developer
Network Administrator
Project Administrator
Group Administrator
Cloud Administrator
Security
End-user/Third-party User

In one currently preferred embodiment, System Administrators and Developers have the same permissions, Project and Group Administrators have the same permissions, and Cloud Administrators and Security have the same permissions. The End-user or Third-party User is optional and external, and may not have access to protected resources, including APIs. Additional granularity of permissions is possible by separating these roles. In various other embodiments, the RBAC security system described above is extended with SAML Token passing. The SAML token is added to the API calls, and the SAML UID is added to the instance metadata, providing end-to-end auditability of ownership and responsibility.

In an embodiment using the roles above, APIs can be grouped according to role. Any authenticated user may:
Describe Instances
Describe Images
Describe Volumes
Describe Keypairs
Create Keypair
Delete Keypair
Create, Upload, Delete Buckets and Keys

### System Administrators, Developers, Project Administrators, and Group Administrators may:

Create, Attach, Delete Volume (Block Store)
Launch, Reboot, Terminate Instance
Register/Unregister Machine Image (project-wide)
Request or Review Audit Scans

### Project or Group Administrators may:

Add and remove other users
Set roles
Manage groups

### Network Administrators may:

Change Machine Image properties (public/private)
Change Firewall Rules
Define Cloud Security Groups
Allocate, Associate, Deassociate Public IP addresses

In this embodiment, Cloud Administrators and Security personnel would have all permissions. In particular, access to the audit subsystem would be restricted. Audit queries may spawn long-running processes, consuming resources. Further, detailed system information is a system vulnerability, so proper restriction of audit resources and results would be restricted by role.

In an embodiment as described above, APIs are extended with three additional type declarations, mapping to the “Confidentiality, Integrity, Availability” (“C.I.A.”) classifications of FIPS 199. These additional parameters would also apply to creation of block storage volumes and creation of object storage “buckets.” C.I.A. classifications on a bucket would be inherited by the keys within the bucket. Establishing declarative semantics for individual API calls allows the cloud environment to seamlessly proxy API calls to external, third-party vendors when the requested C.I.A. levels match.

In one embodiment, a hybrid or multi-vendor cloud uses the VLAN DHCP networking architecture described relative to FIG. 4 and the RBAC controls to manage and secure inter-cluster networking. In this way the hybrid cloud environment provides dedicated, potentially co-located physical hardware with a network interconnect to the project or users' cloud virtual network.

In one embodiment, the interconnect is a bridged VPN connection. In one embodiment, there is a VPN server at each side of the interconnect with a unique shared certificate. A security group is created specifying the access at each end of the bridged connection. In a second embodiment, the interconnect VPN implements audit controls so that the connections between each side of the bridged connection can be queried and controlled. Network discovery protocols (ARP, CDP) can be used to provide information directly, and existing protocols (SNMP location data, DNS LOC records) overloaded to provide audit information.

In the disclosure that follows, the information processing devices as described relative to FIG. 2 and the clusters as described relative to FIG. 3 are used as underlying infrastructure to build and administer various cloud services. Except where noted specifically, either a single information processing device or a cluster can be used interchangeably to implement a single “node,” “service,” or “controller.” Where a plurality of resources are described, such as a plurality of storage nodes or a plurality of compute nodes, the plurality of resources can be implemented as a plurality of information processing devices, as a one-to-one relationship of information processing devices, logical containers, and operating environments, or in an M×N relationship of information processing devices to logical containers and operating environments.

Various aspects of the services implemented in the cloud computing system may be referred to as “virtual machines” or “virtual devices”; as described above, those refer to a particular logical container and operating environment, configured to perform the service described. The term “instance” is sometimes used to refer to a particular virtual machine running inside the cloud computing system. An “instance type” describes the compute, memory and storage capacity of particular VM instances.

Within the architecture described above, various services are provided, and different capabilities can be included through a plug-in architecture. Although specific services and plugins are detailed below, these disclosures are intended to be representative of the services and plugins available for integration across the entire cloud computing system 110.

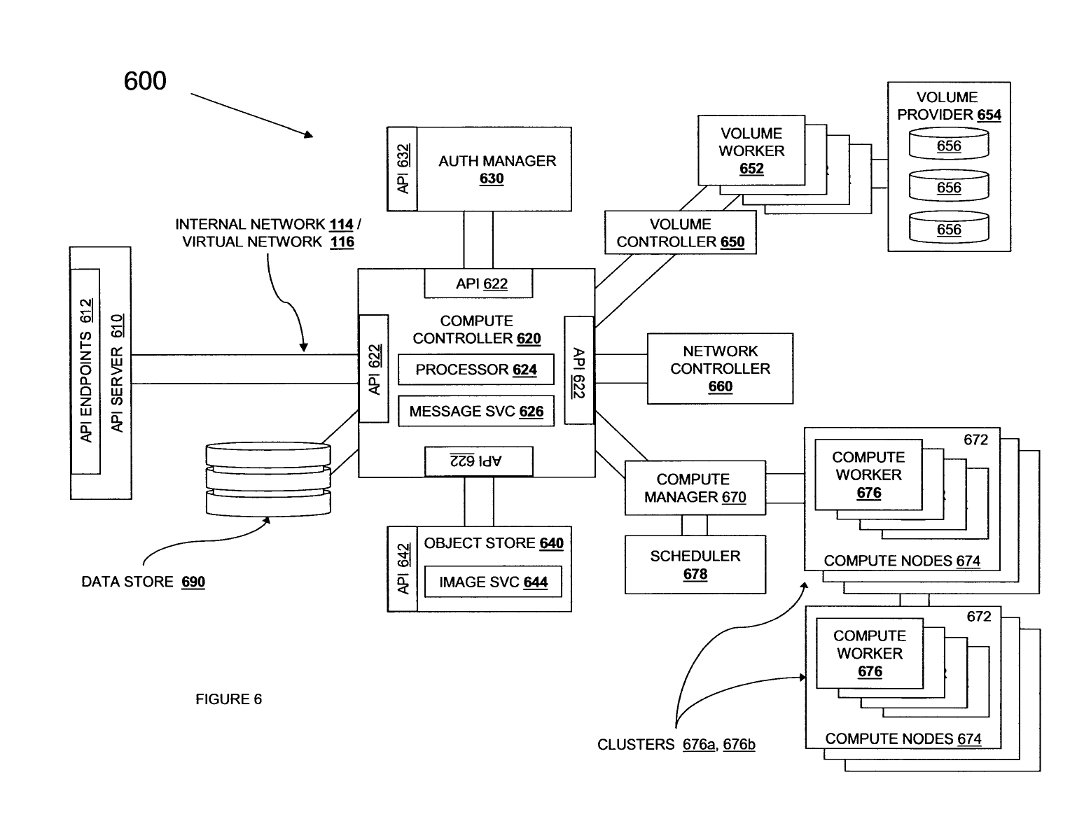

Turning now to FIG. 6, an IaaS-style computational cloud service (a “compute” service) is shown at 600 according to one embodiment. This is one embodiment of a cloud controller 120 with associated cloud service 130 as described relative to FIG. 1. Except as described relative to specific embodiments, the existence of a compute service does not require or prohibit the existence of other portions of the cloud computing system 110 nor does it require or prohibit the existence of other cloud controllers 120 with other respective services 130.

To the extent that some components described relative to the compute service 600 are similar to components of the larger cloud computing system 110, those components may be shared between the cloud computing system 110 and the compute service 600, or they may be completely separate. Further, to the extend that “controllers,” “nodes,” “servers,” “managers,” “VMs,” or similar terms are described relative to the compute service 600, those can be understood to comprise any of a single information processing device 210 as described relative to FIG. 2, multiple information processing devices 210, a single VM as described relative to FIG. 2, a group or cluster of VMs or information processing devices as described relative to FIG. 3. These may run on a single machine or a group of machines, but logically work together to provide the described function within the system.

In one embodiment, compute service 600 includes an API Server 610, a Compute Controller 620, an Auth Manager 630, an Object Store 640, a Volume Controller 650, a Network Controller 660, and a Compute Manager 670. These components are coupled by a communications network of the type previously described. In one embodiment, communications between various components are message-oriented, using HTTP or a messaging protocol such as AMQP, ZeroMQ, or STOMP.

Although various components are described as “calling” each other or “sending” data or messages, one embodiment makes the communications or calls between components asynchronous with callbacks that get triggered when responses are received. This allows the system to be architected in a “shared-nothing” fashion. To achieve the shared-nothing property with multiple copies of the same component, compute service 600 further includes distributed data store 690. Global state for compute service 600 is written into this store using atomic transactions when required. Requests for system state are read out of this store. In some embodiments, results are cached within controllers for short periods of time to improve performance. In various embodiments, the distributed data store 690 can be the same as, or share the same implementation as Object Store 640.

In one embodiment, the API server 610 includes external API endpoints 612. In one embodiment, the external API endpoints 612 are provided over an RPC-style system, such as CORBA, DCE/COM, SOAP, or XML-RPC. These follow the calling structure and conventions defined in their respective standards. In another embodiment, the external API endpoints 612 are basic HTTP web services following a REST pattern and identifiable via URL. Requests to read a value from a resource are mapped to HTTP GETs, requests to create resources are mapped to HTTP PUTs, requests to update values associated with a resource are mapped to HTTP POSTs, and requests to delete resources are mapped to HTTP DELETEs. In some embodiments, other REST-style verbs are also available, such as the ones associated with WebDav. In a third embodiment, the API endpoints 612 are provided via internal function calls, IPC, or a shared memory mechanism. Regardless of how the API is presented, the external API endpoints 612 are used to handle authentication, authorization, and basic command and control functions using various API interfaces. In one embodiment, the same functionality is available via multiple APIs, including APIs associated with other cloud computing systems. This enables API compatibility with multiple existing tool sets created for interaction with offerings from other vendors.

The Compute Controller 620 coordinates the interaction of the various parts of the compute service 600. In one embodiment, the various internal services that work together to provide the compute service 600, are internally decoupled by adopting a service-oriented architecture (SOA). The Compute Controller 620 serves as an internal API server, allowing the various internal controllers, managers, and other components to request and consume services from the other components. In one embodiment, all messages pass through the Compute Controller 620. In a second embodiment, the Compute Controller 620 brings up services and advertises service availability, but requests and responses go directly between the components making and serving the request. In a third embodiment, there is a hybrid model in which some services are requested through the Compute Controller 620, but the responses are provided directly from one component to another.

In one embodiment, communication to and from the Compute Controller 620 is mediated via one or more internal API endpoints 622, provided in a similar fashion to those discussed above. The internal API endpoints 622 differ from the external API endpoints 612 in that the internal API endpoints 622 advertise services only available within the overall compute service 600, whereas the external API endpoints 612 advertise services available outside the compute service 600. There may be one or more internal APIs 622 that correspond to external APIs 612, but it is expected that there will be a greater number and variety of internal API calls available from the Compute Controller 620.

In one embodiment, the Compute Controller 620 includes an instruction processor 624 for receiving and processing instructions associated with directing the compute service 600. For example, in one embodiment, responding to an API call involves making a series of coordinated internal API calls to the various services available within the compute service 600, and conditioning later API calls on the outcome or results of earlier API calls. The instruction processor 624 is the component within the Compute Controller 620 responsible for marshalling arguments, calling services, and making conditional decisions to respond appropriately to API calls.

In one embodiment, the instruction processor 624 is implemented as described above relative to FIG. 3, specifically as a tailored electrical circuit or as software instructions to be used in conjunction with a hardware processor to create a hardware-software combination that implements the specific functionality described herein. To the extent that one embodiment includes computer-executable instructions, those instructions may include software that is stored on a computer-readable medium. Further, one or more embodiments have associated with them a buffer. The buffer can take the form of data structures, a memory, a computer-readable medium, or an off-script-processor facility. For example, one embodiment uses a language runtime as an instruction processor 624, running as a discrete operating environment, as a process in an active operating environment, or can be run from a low-power embedded processor. In a second embodiment, the instruction processor 624 takes the form of a series of interoperating but discrete components, some or all of which may be implemented as software programs. In another embodiment, the instruction processor 624 is a discrete component, using a small amount of flash and a low power processor, such as a low-power ARM processor. In a further embodiment, the instruction processor includes a rule engine as a submodule as described herein.

In one embodiment, the Compute Controller 620 includes a message queue as provided by message service 626. In accordance with the service-oriented architecture described above, the various functions within the compute service 600 are isolated into discrete internal services that communicate with each other by passing data in a well-defined, shared format, or by coordinating an activity between two or more services. In one embodiment, this is done using a message queue as provided by message service 626. The message service 626 brokers the interactions between the various services inside and outside the Compute Service 600.

In one embodiment, the message service 626 is implemented similarly to the message service described relative to FIGS. 5a-5c. The message service 626 may use the message service 140 directly, with a set of unique exchanges, or may use a similarly configured but separate service.

The Auth Manager 630 provides services for authenticating and managing user, account, role, project, group, quota, and security group information for the compute service 600. In a first embodiment, every call is necessarily associated with an authenticated and authorized entity within the system, and so is or can be checked before any action is taken. In another embodiment, internal messages are assumed to be authorized, but all messages originating from outside the service are suspect. In this embodiment, the Auth Manager checks the keys provided associated with each call received over external API endpoints 612 and terminates and/or logs any call that appears to come from an unauthenticated or unauthorized source. In a third embodiment, the Auth Manager 630 is also used for providing resource-specific information such as security groups, but the internal API calls for that information are assumed to be authorized. External calls are still checked for proper authentication and authorization. Other schemes for authentication and authorization can be implemented by flagging certain API calls as needing verification by the Auth Manager 630, and others as needing no verification.

In one embodiment, external communication to and from the Auth Manager 630 is mediated via one or more authentication and authorization API endpoints 632, provided in a similar fashion to those discussed above. The authentication and authorization API endpoints 632 differ from the external API endpoints 612 in that the authentication and authorization API endpoints 632 are only used for managing users, resources, projects, groups, and rules associated with those entities, such as security groups, RBAC roles, etc. In another embodiment, the authentication and authorization API endpoints 632 are provided as a subset of external API endpoints 612.

In one embodiment, the Auth Manager 630 includes a rules processor 634 for processing the rules associated with the different portions of the compute service 600. In one embodiment, this is implemented in a similar fashion to the instruction processor 624 described above.

The Object Store 640 provides redundant, scalable object storage capacity for arbitrary data used by other portions of the compute service 600. At its simplest, the Object Store 640 can be implemented one or more block devices exported over the network. In a second embodiment, the Object Store 640 is implemented as a structured, and possibly distributed data organization system. Examples include relational database systems—both standalone and clustered—as well as non-relational structured data storage systems like MongoDB, Apache Cassandra, or Redis. In a third embodiment, the Object Store 640 is implemented as a redundant, eventually consistent, fully distributed data storage service.

In one embodiment, external communication to and from the Object Store 640 is mediated via one or more object storage API endpoints 642, provided in a similar fashion to those discussed above. In one embodiment, the object storage API endpoints 642 are internal APIs only. In a second embodiment, the Object Store 640 is provided by a separate cloud service 130, so the “internal” API used for compute service 600 is the same as the external API provided by the object storage service itself.

In one embodiment, the Object Store 640 includes an Image Service 644. The Image Service 644 is a lookup and retrieval system for virtual machine images. In one embodiment, various virtual machine images can be associated with a unique project, group, user, or name and stored in the Object Store 640 under an appropriate key. In this fashion multiple different virtual machine image files can be provided and programmatically loaded by the compute service 600.

The Volume Controller 650 coordinates the provision of block devices for use and attachment to virtual machines. In one embodiment, the Volume Controller 650 includes Volume Workers 652. The Volume Workers 652 are implemented as unique virtual machines, processes, or threads of control that interact with one or more backend volume providers 654 to create, update, delete, manage, and attach one or more volumes 656 to a requesting VM.

In a first embodiment, the Volume Controller 650 is implemented using a SAN that provides a sharable, network-exported block device that is available to one or more VMs, using a network block protocol such as iSCSI. In this embodiment, the Volume Workers 652 interact with the SAN to manage and iSCSI storage to manage LVM-based instance volumes, stored on one or more smart disks or independent processing devices that act as volume providers 654 using their embedded storage 656. In a second embodiment, disk volumes 656 are stored in the Object Store 640 as image files under appropriate keys. The Volume Controller 650 interacts with the Object Store 640 to retrieve a disk volume 656 and place it within an appropriate logical container on the same information processing system 240 that contains the requesting VM. An instruction processing module acting in concert with the instruction processor and hypervisor on the information processing system 240 acts as the volume provider 654, managing, mounting, and unmounting the volume 656 on the requesting VM. In a further embodiment, the same volume 656 may be mounted on two or more VMs, and a block-level replication facility may be used to synchronize changes that occur in multiple places. In a third embodiment, the Volume Controller 650 acts as a block-device proxy for the Object Store 640, and directly exports a view of one or more portions of the Object Store 640 as a volume. In this embodiment, the volumes are simply views onto portions of the Object Store 640, and the Volume Workers 654 are part of the internal implementation of the Object Store 640.

In one embodiment, the Network Controller 660 manages the networking resources for VM hosts managed by the compute manager 670. Messages received by Network Controller 660 are interpreted and acted upon to create, update, and manage network resources for compute nodes within the compute service, such as allocating fixed IP addresses, configuring VLANs for projects or groups, or configuring networks for compute nodes.

In one embodiment, the Network Controller 660 is implemented similarly to the network controller described relative to FIGS. 4a and 4b. The network controller 660 may use a shared cloud controller directly, with a set of unique addresses, identifiers, and routing rules, or may use a similarly configured but separate service.

In one embodiment, the Compute Manager 670 manages computing instances for use by API users using the compute service 600. In one embodiment, the Compute Manager 670 is coupled to a plurality of resource pools 672, each of which includes one or more compute nodes 674. Each compute node 674 is a virtual machine management system as described relative to FIG. 3 and includes a compute worker 676, a module working in conjunction with the hypervisor and instruction processor to create, administer, and destroy multiple user- or system-defined logical containers and operating environments—VMs—according to requests received through the API. In various embodiments, the pools of compute nodes may be organized into clusters, such as clusters 676a and 676b. In one embodiment, each resource pool 672 is physically located in one or more data centers in one or more different locations. In another embodiment, resource pools have different physical or software resources, such as different available hardware, higher-throughput network connections, or lower latency to a particular location.

In one embodiment, the Compute Manager 670 allocates VM images to particular compute nodes 674 via a Scheduler 678. The Scheduler 678 is a matching service; requests for the creation of new VM instances come in and the most applicable Compute nodes 674 are selected from the pool of potential candidates. In one embodiment, the Scheduler 678 selects a compute node 674 using a random algorithm. Because the node is chosen randomly, the load on any particular node tends to be non-coupled and the load across all resource pools tends to stay relatively even.

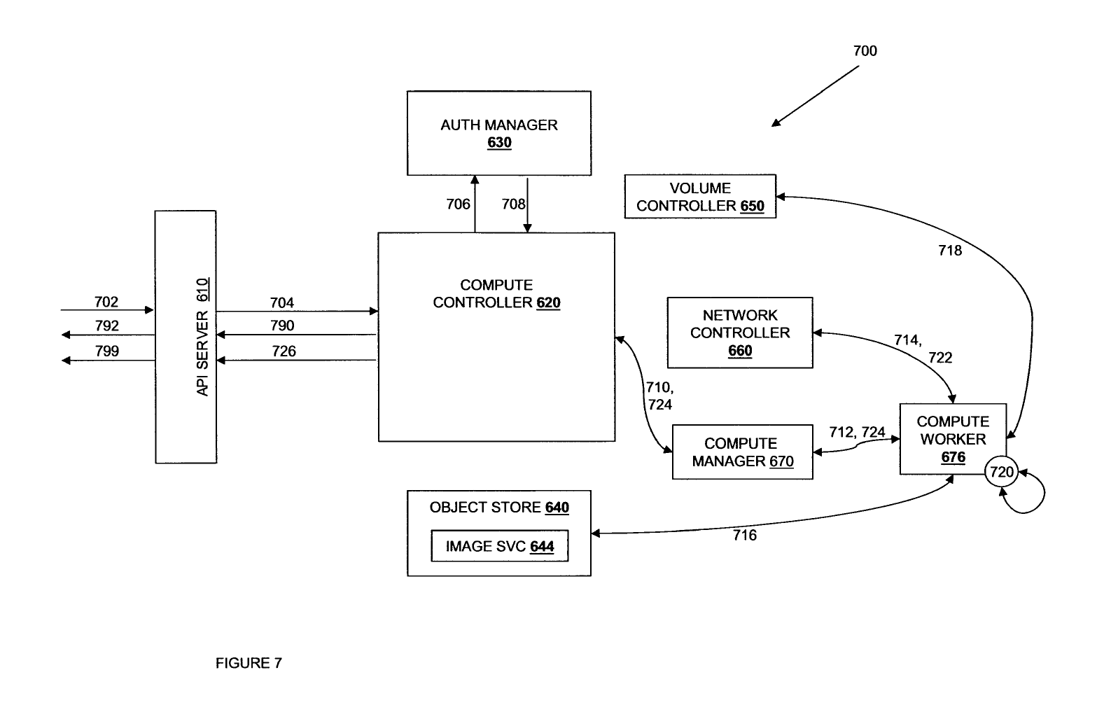

Turning now to FIG. 7, a diagram showing one embodiment of the process of instantiating and launching a VM instance is shown as diagram 700. In one embodiment, this corresponds to steps 458 and/or 459 in FIG. 4b. Although the implementation of the image instantiating and launching process will be shown in a manner consistent with the embodiment of the compute service 600 as shown relative to FIG. 6, the process is not limited to the specific functions or elements shown in FIG. 6. For clarity of explanation, internal details not relevant to diagram 700 have been removed from the diagram relative to FIG. 6. Further, while some requests and responses are shown in terms of direct component-to-component messages, in at least one embodiment the messages are sent via a message service, such as message service 626 as described relative to FIG. 6.

At time 702, the API Server 610 receives a request to create and run an instance with the appropriate arguments. In one embodiment, this is done by using a command-line tool that issues arguments to the API server 610. In a second embodiment, this is done by sending a message to the API Server 610. In one embodiment, the API to create and run the instance includes arguments specifying a resource type, a resource image, and control arguments. A further embodiment includes requester information and is signed and/or encrypted for security and privacy. At time 704, API server 610 accepts the message, examines it for API compliance, and relays a message to Compute Controller 620, including the information needed to service the request. In an embodiment in which user information accompanies the request, either explicitly or implicitly via a signing and/or encrypting key or certificate, the Compute Controller 620 sends a message to Auth Manager 630 to authenticate and authorize the request at time 706 and Auth Manager 630 sends back a response to Compute Controller 620 indicating whether the request is allowable at time 708. If the request is allowable, a message is sent to the Compute Manager 670 to instantiate the requested resource at time 710. At time 712, the Compute Manager selects a Compute Worker 676 and sends a message to the selected Worker to instantiate the requested resource. At time 714, Compute Worker identifies and interacts with Network Controller 660 to get a proper VLAN and IP address as described in steps 451-457 relative to FIG. 4. At time 716, the selected Worker 676 interacts with the Object Store 640 and/or the Image Service 644 to locate and retrieve an image corresponding to the requested resource. If requested via the API, or used in an embodiment in which configuration information is included on a mountable volume, the selected Worker interacts with the Volume Controller 650 at time 718 to locate and retrieve a volume for the to-be-instantiated resource. At time 720, the selected Worker 676 uses the available virtualization infrastructure as described relative to FIG. 2 to instantiate the resource, mount any volumes, and perform appropriate configuration. At time 722, selected Worker 676 interacts with Network Controller 660 to configure routing as described relative to step 460 as discussed relative to FIG. 4. At time 724, a message is sent back to the Compute Controller 620 via the Compute Manager 670 indicating success and providing necessary operational details relating to the new resource. At time 726, a message is sent back to the API Server 610 with the results of the operation as a whole. At time 799, the API-specified response to the original command is provided from the API Server 610 back to the originally requesting entity. If at any time a requested operation cannot be performed, then an error is returned to the API Server at time 790 and the API-specified response to the original command is provided from the API server at time 792. For example, an error can be returned if a request is not allowable at time 708, if a VLAN cannot be created or an IP allocated at time 714, if an image cannot be found or transferred at time 716, etc.

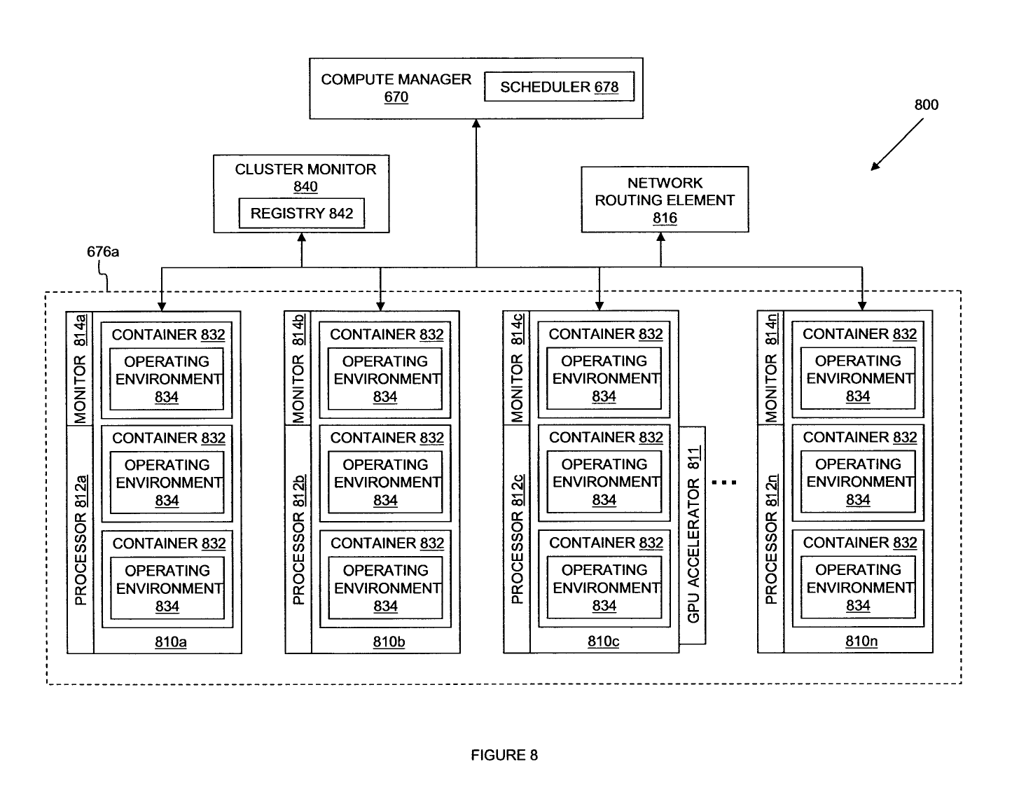

Turning now to FIG. 8, illustrated is a system 800 that includes the compute cluster 676a, the compute manager 670, and scheduler 678 that were previously discussed in association with FIG. 6. Note that where particular implementations are similar within the present disclosure, similar names and reference numbers may be used, but such similarity is for clarity only and should not be considered limiting.

In the illustrated embodiment of FIG. 8, the compute cluster 676a includes a plurality of information processing systems (IPS) 810a-810n that are similar to the information processing systems described relative to FIGS. 2 and 3 above. The IPSs may be homogeneous or non-homogeneous depending on the computer hardware utilized to form the compute cluster 676a. For instance, some cloud systems, especially those created within “private” clouds, may be created using repurposed computers or from a large but non-homogenous pool of available computer resources. Thus, the hardware components of the information processing systems (IPS) 810a-810n, such as processors 812a-812n, may vary significantly.

Each information processing system 810a-810n includes one or more individual virtualization containers 832 with operating environments 834 disposed therein (together referred to as a “virtual machine” or “VM”). As described above, the compute manager 670 allocates VM images to particular information processing systems via the scheduler 678. For example, as requests for the creation of new VM instances come in, the scheduler 678 selects the information processing system on which to instantiate the requested VM. In the illustrated embodiment, the scheduler 678 makes this determination based on characteristics of the information processing systems 810a-810n (i.e., metadata about the information processing systems). Notably, because the information processing systems in the compute cluster 676a may be non-homogeneous, VM performance varies based on the capabilities of the information processing systems hosting the VM instance. For instance, the information processing system 810c is the sole system that includes a GPU accelerator 811, and this may process graphics-intensive compute jobs more efficiently than other information processing systems. Further, with regard to the network infrastructure of the compute cluster 676a, the bandwidth and network load may vary between information processing systems 810a-810n and individual VMs executing on the IPSs, impacting the network performance of identical VMs.

In more detail, the information processing systems 810a-810n respectively include monitors 814a-814n that are operable to gather metadata about the information processing systems and the VM instances executing thereon. The monitors 814a-814n may be implemented in software or in tailored electrical circuits or as software instructions to be used in conjunction with processors 812a-812n to create a hardware-software combination that implements the specific functionality described herein. To the extent that software is used to implement the monitors 814a-814n, the information processing systems 810a-810n may include software instructions stored on non-transitory computer-readable media. In one embodiment, the monitors 814a-814b may be hardware-based, out-of-band management controllers coupled to the respective information processing systems 810a-810n. In such an instance, the monitors may communicate with the network of system 800 with a physically separate network interface than their host information processing systems and may be available when the processing systems are not powered-on. In another embodiment, the monitors 814a-814b may be software-based, in-band management clients installed on the host operating systems of the information processing systems. In such an embodiment, the monitor clients may only be available when the host information processing systems are powered-on and initialized. In other embodiments, the monitors 814a-814n may be any number of various components operable to collect metadata about a host information processing system. In one embodiment, the monitors 814a-814n are implemented, at least in part, as IPMI subsystems 240 as described relative to FIG. 2b. In a further embodiment, the monitors 814a-814n include an IPMI subsystem 240, but also include further monitors as described herein.

Monitors 814a-814n gather both static metadata and dynamic metadata about the information processing systems 810a-810n. With regard to static metadata, the monitors 814a-814n may gather the physical characteristics of the underlying computer such as processor type and speed, memory type and amount, hard disk storage capacity and type, networking interface type and maximum bandwidth, the presence of any peripheral cards such as graphics cards or GPU accelerators, and any other detectable hardware information. In one embodiment, this information is gathered using the IPMI subsystem 240's hardware inventory functionality. With respect to dynamic metadata, the monitors 814a-814n may gather operating conditions of the underlying computer such as processor utilization, memory usage, hard disk utilization, networking load and latency, availability and utilization of hardware components such as GPU accelerators. Further, not only do the monitors 814a-814n observe the dynamic operating conditions of their respective information processing system as a whole, but, importantly, they also include hooks into individual containers 832 and operating environments 834 so they can also monitor static and dynamic conditions as they appear from “inside” of a VM. For instance, monitor 814a can determine the virtual hardware characteristics of each VM executing on information processing system 810a and also capture network load and latency statistics relative to other VMs on the information processing system and in the same VLAN as they appear to a specific VM. In one embodiment, the monitors 814a-814n communicate with agents executing within a VM's operating system to query operational statistics, or, in another embodiment, the monitors gather VM metadata through hypervisor management infrastructure.

As shown in the illustrated embodiment of FIG. 8, the system 800 includes a cluster monitor 840 that is operable to oversee operation of the compute cluster 676a. One aspect of cluster operation for which the cluster monitor 840 is responsible is management of the metadata collected by the monitors 814a-814n. Specifically, the cluster monitor 840 includes a registry 842 that stores metadata received from the monitors 814a-814n. Thus, the collective metadata stored in the registry 842 reflects the current state of the compute cluster 676a—both globally and relative to particular point-to-point connections within the cluster. In some embodiments, the cluster monitor 840 may analyze, categorize, or otherwise process the metadata. After the metadata has been received and stored in the registry 842, the cluster monitor 840 makes the metadata available for querying by the scheduler 678. In that regard, when the scheduler 678 is tasked with creating a new VM instance on an information processing system in the compute cluster 676a, it can query the metadata stored in the registry 842 to determine which information processing system meets the criteria of the VM instance. Additionally, if the scheduler is tasked with scheduling a compute task on a previously created VM instance, it can query the registry 842 for metadata describing the current operating conditions of every VM instance executing in the compute cluster 676a. The scheduler 678 may utilize the metadata stored in the registry 842 in numerous additional manners, as will be discussed below. Further, in some embodiments, the cluster monitor 840 may collect operational characteristics of the compute cluster 676a itself, such as network load and latency between the compute cluster and other clusters or points outside of the cloud system 800.

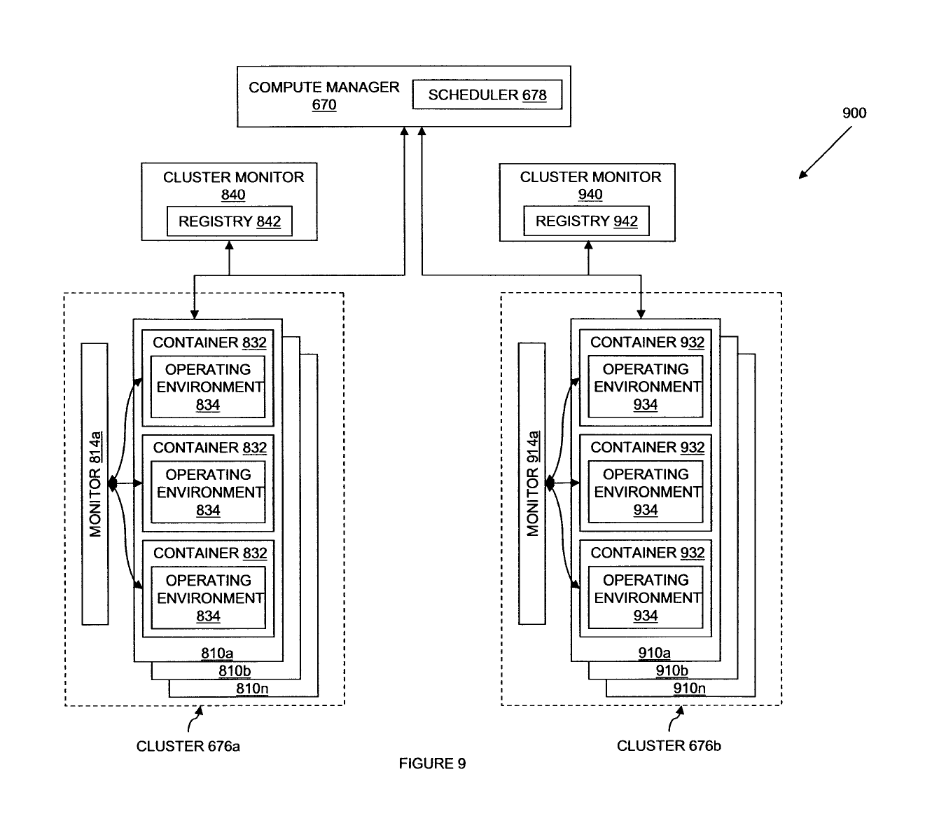

With reference now to FIG. 9, illustrated is a system 900 that is similar to the system 800 of FIG. 8 but also includes the compute cluster 676b. The compute cluster 676b includes a plurality of information processing systems (IPS) 910a-910n that are similar to the information processing systems 810a-810n described in association with FIG. 8. The IPSs may be homogeneous or non-homogeneous depending on the computer hardware utilized to form the compute cluster 676b. The information processing systems 910a-910n respectively include monitors 914a-914n that are operable to gather metadata about the information processing systems and the VM instances executing thereon. As shown in the illustrated embodiment of FIG. 9, the system 900 also includes a cluster monitor 940 that is operable to oversee operation of the compute cluster 676b and includes a registry 942 for the storage of metadata received from the monitors 914a-914n. Notably, in multi-cluster systems such as system 900, the scheduler 678 is operable to query metadata from both the registry 842 and the registry 942 to make VM allocation determinations. For instance, if the scheduler 678 is tasked with choosing a compute cluster in which to instantiate a large number of VM instances for a bandwidth intensive job, it may query metadata from both the registry 842 and the registry 942 to determine which cluster includes not only a sufficient number of available virtual containers for VM instances but also which cluster currently includes sufficient available bandwidth between the information processing systems comprising the cluster. Further, in some embodiments, the cluster monitor 940 may collect dynamic inter-cluster characteristics such as network load and latency between the compute nodes of the compute clusters 676b and the compute nodes of the compute cluster 676b.

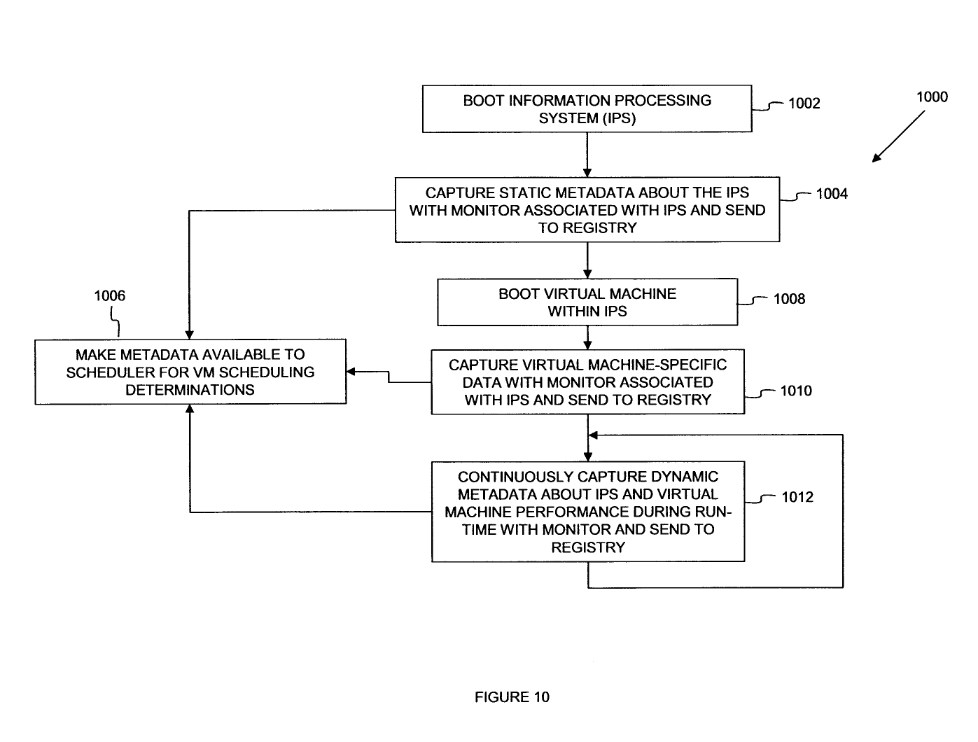

With reference now to FIG. 10, illustrated is a simplified flow chart of a method 1000 for metadata discovery and metadata-aware scheduling according to aspects of the present disclosure. In one embodiment, the method 1000 is carried out in the context of the infrastructure of systems 800 and/or 900 in FIGS. 8 and 9. In general, metadata about information processing system and VM instances is gathered in three phases—during boot up of an information system, during boot up of a specific VM, and during workload processing. The gathered metadata may be used by the scheduler 678 to make scheduling determinations at any time subsequent to the first metadata collection.

In more detail, the method 1000 begins at block 1002 where an information processing system, such as one of the information processing systems 810a-810n, is booted up, rebooted, power cycled, or similarly initialized. As an aspect of this, the monitor associated with the information processing system is also initialized and a communication link between the monitor and the compute cluster managing the information processing system is established. Next, in block 1004, the monitor interrogates the host information processing system for static metadata such as the hardware configuration of the processing system. As this metadata is collected by the monitor, it transmits it to a cluster monitor, such as cluster monitor 840, so that it may be stored in a registry, such as registry 842. In block 1006, the metadata is made available to a scheduler, such as scheduler 678, so that it can query the metadata and make determinations about which information processing system is suitable to host VM instances.

When the scheduler chooses an appropriate information processing system on which to instantiate a VM instance, the method 1000 proceeds to block 1008 where a VM is booted within the selected information processing system. As an aspect of this, the monitor detects the presence of a new VM and establishes the communication channels necessary to interrogate the VM or underlying hypervisor. The method 1000 next proceeds to block 1010 where the monitor captures virtual machine specific metadata. For example, the monitor may collect the virtual hardware configuration of the VM and perform some initial bandwidth and latency tests to collect network statistics as they appear from “inside” of the virtual machine. Thus, the metadata collected in block 1010 may include both static and dynamic metadata. As the VM metadata is collected, it is transmitted to the cluster monitor and made available to the scheduler, as shown in block 1006. As the metadata describing various VMs instantiations executing in one or more compute clusters is made available to the scheduler, the scheduler is operable to query the metadata and schedule processing jobs on running VMs based on virtual hardware capabilities and network load and latency as they appear to the running VMs.

Next, the method 1000 proceeds to block 1012, where the monitor continuously captures dynamic metadata describing the operational state of the information processing system and VM instance throughout the life cycle of each. For instance, the monitor may capture disk activity, processor utilization, bandwidth, and special feature usage of both the information processing system and, where applicable, the VM instance. Again, as the metadata is collected, it is continuously sent to the registry so that it may be made available to the scheduler in block 1006. The dynamic metadata may thus be used by the scheduler to make on-the-fly scheduling decisions based on the most up-to-date system status. In this manner, the scheduler is operable to make the most efficient use of the computing resources available to it.

It is understood that the method 1000 described above for metadata discovery and metadata-aware scheduling is simply an example and in alternative embodiments, additional and/or different steps may be included in the method. For example, the scheduler may utilize the metadata in a number of various additional and/or different manners, as will be described below.

First, metadata collected by a monitoring system as described in association with FIGS. 8, 9, and 10 may be utilized for reporting purposes. Some conventional cloud-based systems include reporting capabilities, but the metadata collection system described above expands the range of information available to report. For example, the monitors capture both static and dynamic metadata that collectively describe an initial state of a cloud-based network and also instantaneous operational statistics of physical and virtual hardware deployed within the network. Further, collected metadata may be utilized to determine network status as it appears from within specific virtual machine instances.

Second, as mentioned briefly above, the metadata collected by a monitoring system as described in association with FIGS. 8, 9, and 10 may be utilized to make efficient use of cloud-computing resources. A perceived advantage of cloud-based infrastructure services is that any differences in underlying capability and architecture of systems that form a cloud can be minimized through the use of virtualization. However, adopting a completely homogenous view of virtual machine instantiation (i.e., the view that any virtual machine image may be instantiated on any computing resources in the cloud network) prevents the most efficient use of the cloud infrastructure. Ignoring underlying cloud infrastructure differences impedes the performance of VM instances, for example, because underlying assumptions about the satisfaction of VM image requirements are not met in full or in part. Further, some production environments require specialized hardware to be available to various VM instances to run optimally. For example, database instances may need to be scheduled on hosts with a greater ratio of disks per core than general purpose VMs, or a research cluster may have instances that must be scheduled on hosts that can provide GPU capabilities. Other clients require separate development and production hardware without incurring the overhead of creating a specific cloud environment dedicated to each potential consumer's needs and concerns.

Both virtual and physical compute workload performance is strongly influenced by performance capabilities of the underlying information processing system where the workload is executing. For example; the speed at which a compute workload can write a file to disk is based on the speed of the underlying disk, flash or other computer readable medium. The total computational workload is bounded by the speed, parallelism and temperature-based performance of the chipset and central processing unit. As described above, these are different within a cloud and, due to differences in airflow, placement, vibration, heat, and manufacturing variability, among other factors, these can even vary between apparently “identical” systems.

The ability to efficiently schedule resources onto a pool of physical resources is influenced in part by the knowledge of what “full utilization” or “optimal utilization” means in different contexts. In one embodiment, various workloads and benchmarks are used to measure total capacity of a system under a variety of different scenarios. As is known in the art, benchmarks are designed to mimic a particular type of workload on a component or system. Synthetic benchmarks do this by running specially created programs that impose the workload on the component. Application benchmarks run real-world programs on the system. Although application benchmarks usually give a much better measure of real-world performance on a given system, synthetic benchmarks are useful for testing individual components, like a hard disk or networking device.

In this embodiment, each underlying information processing system such as the systems 810 and 910 is measured relative to absolute capacity along a number of different orthogonal dimensions, including but not limited to disk capacity, disk throughput, memory size, memory bandwidth, network bandwidth, and computational capacity. These can be measured using various synthetic benchmarks known in the art that focus on or stress particular known subsystems. For example, Sisoft sells the “Sandra” benchmarking tool with independent tests for CPU/FPU speed, CPU/XMM (Multimedia) speed, multi-core efficiency, power management efficiency, GPGPU performance, filesystem performance, memory bandwidth, cache bandwidth, and network bandwidth. Other well-known benchmarks include measurements file conversion efficiency, cryptographic efficiency, disk latency, memory latency, and performance/watt of various subsystems. Standard benchmarks include SPEC (including SPECint and SPECfp), Iometer, Linpack, LAPACK, NBench, TPC, BAPCo Sysmark, and VMmark.

In a further embodiment, known “typical” workloads are used to provide better “real world” performance metrics. These are a step up from application benchmarks because they include a suite of programs working together. For example, a system can be benchmarked by executing a known series of commands to run a series of database queries, render and serve a web page, balance a network load, or do all of the above. In this embodiment, the effect of a “typical” workload can be related to a “synthetic” benchmark by monitoring the use of various subsystems while the typical workload is being executed and then relating the total amount of usage to a known measurement from a synthetic benchmark. These relations can be instantaneous at a point in time, an operating range, min/max/average, or can represent total usage over time.

In another embodiment, measurement of static capacity is done when a new physical machine is brought up. In one embodiment, one or more synthetic benchmarks are run on the hypervisor or and unloaded machine to determine measures of total system capacity along multiple dimensions. In a second embodiment, one or more “utility” virtual machines are used on bootup to execute benchmarks and measure the total capacity of a machine. A third embodiment uses both methods together to measure “bare metal” capacity and relate it to a known sequence or set of “typical” workloads as executed in utility VMs. The measured capacity would be observed by monitor 814 and recorded in registry 842.

In one embodiment, a scheduler, such as scheduler 678, may utilize static and dynamic metadata collected from a plurality of running VM instances to select one or more VM instances on which to execute various compute jobs. As is understood by one of ordinary skill in the art of cloud computing, different compute jobs may require different types of calculations that are more efficiently computed on different types of hardware. For instance, a graphics-intensive compute job may be most efficiently completed on an information processing system that includes a GPU accelerator card. In the example embodiment of system 800 in FIG. 8, if the scheduler 678 receives a graphics-intensive compute job, it may query the registry 842 to determine that information processing system 810c includes the GPU accelerator 811. Thus, the scheduler is more likely to create or utilize and an existing VM instance on information processing system 810c for the compute job. Further, even after the compute job is initiated in a VM instance on information processing system 810c, dynamic metadata about the current operational status is relayed to the scheduler via the cluster monitor. Thus, even if the chosen VM instance has access to the GPU accelerator card 811, the VM may not be able to “see” from within the VM that the card 811 is being heavily utilized by another VM. If the dynamic metadata collected about the GPU accelerator indicates as much, the scheduler may divert the compute job to another VM instance with access to a GPU accelerator with less utilization. In this manner, the scheduler is operable to dynamically monitor changes in cloud resources—as viewed from a global perspective and from within individual VMs—and divert on-going compute jobs based on such changes. In another example, compute jobs may require the movement of large data sets between specific nodes in a cloud-network. In such a scenario, the scheduler may query dynamic metadata stored by cluster monitors to determine the network load and latency between various points in the compute cluster. For example, a scheduler tasked with a map-reduce compute job may query dynamic metadata describing the latency between a database containing a data set needed for the map-reduce job and various VM instances in the compute cluster. If the latency between a first VM instance and the database—as viewed from inside or outside of the first VM—is lower than the latency between a second VM instance and the database, the scheduler may select the first VM for the portion of the map-reduce job requiring the data set. In a further example, a scheduler may be operable to dynamically scale-up or scale-down the resources for a compute job based on dynamic metadata describing the operational status of a compute cluster. For instance, if a scheduler detects that information processing systems in a compute cluster have available processor cycles based on collected metadata, the scheduler may automatically scale up the number of VM instances simultaneously working on the compute job. As an aspect of this, the information processing systems on which the VM instance replicas will be instantiated may be chosen so that an effective bandwidth between the original node and the replica nodes is the maximum possible, therefore reducing replication time. Additionally, it is understood that the collected metadata describing the makeup and operational state of a cloud-based system may be utilized in a number or additional and/or different manners.

In a further embodiment, an IPMI sensor subsystem is used to monitor the performance of the physical information processing system as well as the various VMs to control the scheduling and allocation of jobs to various hypervisors.

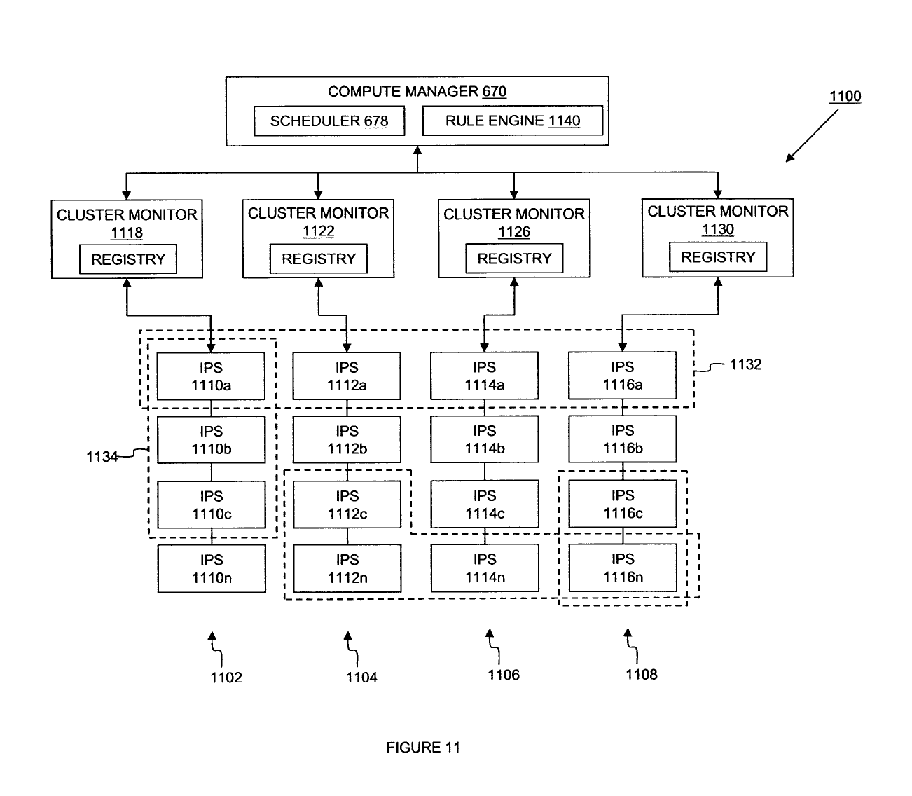

Referring now to FIG. 11, illustrated is a system 1100 that includes compute clusters 1102, 1104, 1106, and 1108. These compute clusters may be similar to the compute clusters 676a and 676b of FIGS. 6, 8, and 9. In general, the system 1100 is operable to efficiently utilize an underlying non-homogenous computer hardware infrastructure through the use of availability zones and metadata. In more detail, the compute cluster 1102 includes a plurality of information processing systems 1110a-1110n that may be non-homogenous in some embodiments. Likewise, the compute clusters 1104, 1106, and 1108 respectively include information processing systems 1112a-1112n, 1114a-1114n, 1116a-1116n. As with the information processing systems in FIGS. 8 and 9, the information processing systems include monitors to collect static and dynamic metadata about the information processing systems and any VM instances executing thereon, including embodiments with physical IPMI subsystems, virtual IPMI subsystems, or both. Further, each compute cluster includes a respective cluster monitor 1118, 1122, 1126, and 1130, each having a registry in which metadata collected from the compute nodes within the respective clusters is stored. The compute manager 670 ultimately manages all of the cluster monitors 1118, 1122, 1126, and 1130 and includes the scheduler 678. As described above, the scheduler is operable to query metadata from the cluster monitors 1118, 1122, 1126, and 1130 in order to make efficient scheduling decisions.

In the illustrated embodiment, the scheduler 678 is operable to define availability zones based on the collected metadata. An availability zone is a logical partition of information processing systems, VM instances, or volume services within the larger system 1100. Availability zones are defined at the host configuration level, and thus provide a method to segment compute nodes by arbitrary criteria, such as hardware characteristics, physical location, or operational status, and other factors described by metadata available to the scheduler 678. Therefore, an embodiment of an availability zone may encompass information processing systems in one cluster 676a or across both clusters 676a and 676b. Notably, the designation of compute nodes into availability zones is a logical distinction based upon capabilities and current performance, and not necessarily on geography, or in other embodiments. In general, the scheduler 678 is operable to determine on which information processing system a new instance should be created based on its inclusion in one or more availability zones.

In one embodiment, for example, static availability zones may be defined based on hardware characteristics of information processing systems in the system 1100. For instance, an availability zone 1132 may encompass information processing systems with high performance processing capabilities as defined by processor type and speed that is above certain thresholds. In the illustrated embodiment of FIG. 11, information processing systems 1110a, 1112a, 1114a, and 1116a may be placed into the availability zone 1132 by the scheduler 678 because metadata collected by monitors associated with the information processing systems reports that each have processors that meet the performance thresholds. In this manner, when the scheduler 678 receives a compute job with high computational requirements, the scheduler may instantiate a VM instance on one of the information processing systems 1110a, 1112a, 1114a, and 1116a in the availability zone 1132 to perform the compute job.

In a further example, the scheduler 678 may also define dynamic availability zones based on dynamic metadata—such as processor load, network load, and network latency—collected by monitors within the system 1100. For instance, a dynamic availability zone 1134 may encompass information processing systems with available network bandwidth above a define threshold. As mentioned above, network bandwidth metadata may describe network conditions as they appear from “inside” a VM instance executing on an information processing system. In the illustrated embodiment of FIG. 11, information processing systems 1110a, 1110b, and 1110c may be placed into the availability zone 1134 based on their current bandwidth availability as described by metadata stored in the cluster monitor 1118 and queried by the scheduler 678. Notably, the availability zone 1134 may dynamically encompass different information processing systems within the system 1100 as network loads shift within the system. Further, availability zones may overlap when a single information processing system meets the criteria of multiple availability zones. For instance, the information processing system 1110a is a member of both the availability zone 1132 and 1134 because it includes a high performance processor and also currently has available network bandwidth.

In one embodiment, the scheduler 678 utilizes a rules engine 1140 that includes a series of associated rules regarding costs and weights associated with desired compute node characteristics. When deciding where to instantiate a VM instance, rules engine 1140 calculates a weighted cost associated with selecting each available information processing system. In one embodiment, the weighted cost is the sum of the costs associated with various requirements of a VM instance. The cost of selecting a specific information processing system is computed by looking at the various capabilities of the system relative to the specifications of the instance being instantiated. The costs are calculated so that a “good” match has lower cost than a “bad” match, where the relative goodness of a match is determined by how closely the available resources match the requested specifications. As an example, a VM instance may require the availability of a GPU accelerator for a graphically-intense compute job. And, selecting an information processing system that includes a GPU accelerator card for a VM instantiation with GPU acceleration requirement may incur no cost or a small cost. Whereas selecting an information processing system that only includes a low-end, integrated graphics hardware for the same VM instance may incur a large cost. In a second embodiment, a weighted cost is calculated using an exponential or polynomial algorithm. In the simplest embodiment, costs are nothing more than integers along a fixed scale, although costs can also be represented by floating point numbers, vectors, or matrices.

In one embodiment, VM instantiation requirements may be hierarchical, and can include both hard and soft constraints. A hard constraint is a constraint that must be met by a selected information processing system. In one embodiment, hard constraints may be modeled as infinite-cost requirements. A soft constraint is a constraint that is preferable, but not required. Different soft constraints may have different weights, so that fulfilling one soft constraint may be more cost-effective than another. Further, constraints can take on a range of values, where a good match can be found where the available resource is close, but not identical, to the requested specification. Constraints may also be conditional, such that constraint A is a hard constraint or high-cost constraint if constraint B is also fulfilled, but can be low-cost if constraint C is fulfilled.

As implemented in one embodiment, the constraints are implemented as a series of rules with associated cost functions. The rules engine 1140 may store and apply the rules to scheduling determination made by the scheduler 678. These rules can be abstract, such as preferring nodes that don't already have an existing instance from the same project or group. Other constraints (hard or soft), may include: a node with available GPU hardware; a node with an available network connection over 100 Mbps; a node that can run specific operating system instances; a node in a particular geographic location, etc.

When evaluating the cost to place a VM instance on a particular node, the constraints are computed to select the group of possible nodes, and then a weight is computed for each available node and for each requested instance. This allows large requests to have dynamic weighting. For example, if 1000 instances are requested, the consumed resources on each node are “virtually” depleted so the cost can change accordingly.

The behavior of the scheduler 678 varies based on the schedule driver in use; however, the logic utilized to determine the compute nodes in an availability zone is consistent across all scheduling algorithms. In one embodiment, if the request to create an instance supplies a desired availability zone then the instance is scheduled across all compute nodes that are members of the availability zone using the other rules specified within the scheduler. If a request to create an instance does not supply a desired availability zone then the scheduler creates a list of available compute nodes within a default availability zone and using the other rules specified within the scheduler 678 to determine the host on which to schedule the instance.

The combination of the scheduler and defined availability zones allows the use of heterogeneous hardware for the underlying system. Hosts can be categorized into availability modes according to their performance characteristics as measured and recorded by monitors distributed throughout the system 1100. These characteristics can be either static, such as different types of hardware, semi-dynamic, such as by operating system type, or fully dynamic, determined by load, latency or other runtime-variable characteristics.

For example, in one embodiment there are two tiers of hardware, a general tier that is lower powered, and a special tier that is higher powered and reserved for instances that require higher performance. In this embodiment, general VMs can be allocated in the “general” availability zone, and other VMs in a “high performance” availability zone. Because the allocation rules can be hierarchical, the requested availability zone can be specified as a high or highest-priority rule, one that will be fulfilled before any rule is applied. Therefore the general allocation can be made intelligently both with regard to the availability zones as well as within each zone. If the rule allocating the availability zone is set as a hard requirement, then allocations within the availability zone can fail if no more resources are available. If the requirement is kept as a weighted preference, however, then cross-availability zone allocations will still be possible but will be discouraged.

In one embodiment, compute manager 670 includes a PXE based deployment engine paired with a decision matrix within scheduler 678 using information stored in or provided by the registry 842. The cluster monitors 1118, 1122, 1126, and 1130 collect and maintain information including the “static” capabilities information as determined by an initial audit, an initial benchmark, or both, as well as “dynamic” information provided by the software monitors and IPMI sensors. In various embodiments, the “external” IPMI-based sensors and monitors are used to complement or check the “internal” software-based sensors operating from the hypervisor and within various VMs. Further, the registry or registries can be used to track physical position for various physical machines and virtual machines within the datacenter and correlate that with areas of higher and lower temperature.

In this embodiment, the compute manager 670 includes a rule engine 1140 that has as a fitness function per-VM, per-information-processing-system, per-rack, and whole-datacenter efficiency and utilization targets. For example, a VM could have a target driven by a customer service level agreement; an information processing system could have a target level driven by an average utilization rate of 70%, and a rack and datacenter could have an ambient temperature metric. In this embodiment, system locality and position in the datacenter are correlated by the compute manager 670 by keeping specific network ports associated with specific spaces in racks and by correlating network switches with floor tile locations. Using this method, the compute manager 670 can use rack and floor location information to provide fine-grained control over the placement of workloads in the datacenter.

In another embodiment, information from the monitors, including IPMI monitors, is used to measure the load associated with various VMs and to drive overall efficiency. During the initial benchmarking phase, an optimal efficiency band can be computed where one or more usage characteristics can be optimized on a per/watt basis. For example, in one embodiment, a particular information processing system 1110 is most efficient at an ambient temperature of 23 degrees C. and a fan speed at 30% of max. By monitoring the load on the system, the compute manager 670 can place virtual workloads on a system until the heat load of the physical machine causes an increase in fan speed greater than 30%. In this way, the scheduler can be tuned to individually optimize the efficiency of the information processing system 1110 actually running the workload.

In a further embodiment, by correlating the information processing system where a virtual machine is running and the additional heat load generated by the virtual machine, the heat load can be finely controlled and optimized across individual racks and the whole datacenter.

One advantage of various embodiments of the present disclosure is allowing the operator of a cloud computing system to more efficiently use the resources of the system, especially when the resources associated with various physical and virtual devices vary. Making more efficient use of the resources and eliminating waste is desirable. Another advantage of various embodiments is that the embodiments described herein can be used to increase the throughput of a cloud computing system as a whole by more evenly distributing computational tasks across the components of the system, relative to the capabilities of the underlying systems. A third advantage of various embodiments is that whole-rack or whole-datacenter operations can be effectively controlled and optimized. A fourth advantage of various embodiments is that IPMI sensor management systems can be used to monitor and control both physical and virtual workloads.

Even though illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A cloud computing system, comprising:
a plurality of computing devices configured to host virtual machine instances, each computing device in the plurality of computing devices including a monitor operable to collect metadata about the associated computing device;
a registry operable to receive and store the metadata from the plurality of computing devices; and
a scheduler operable to select a host computing device out of the plurality of computing devices on which to instantiate a virtual machine instance based on the metadata stored in the registry.

2. The cloud computing system of claim 1, wherein the plurality of computing devices are non-homogeneous.

3. The cloud computing system of claim 1, wherein each monitor is operable to collect static metadata describing hardware configurations of the associated computing device.

4. The cloud computing system of claim 1, wherein each monitor is operable to collect dynamic metadata describing operating conditions of the associated computing device.

5. The cloud computing system of claim 4, wherein each monitor is operable to collect dynamic metadata describing one of bandwidth availability, processor availability, memory usage, and hard disk utilization of the associated computing device.

6. The cloud computing system of claim 1, wherein each monitor is operable to collect metadata associated with a virtual machine instance hosted on the associated computing device.

7. The cloud computing system of claim 6, wherein each monitor is operable to collect metadata describing network conditions as they appear to the virtual machine instance.

8. The cloud computing system of claim 1,
further including a plurality of virtual machine instances executing within the plurality of computing devices; and
wherein the scheduler is further operable to select one of the virtual machine instances on which to schedule a compute job based on the metadata stored in the registry.

9. The cloud computing system of claim 1,
wherein the virtual machine image includes criteria for a host computing device;
wherein the scheduler is operable to assign costs to selecting each of the plurality of computing devices based on how closely each of the plurality of computing devices meets the criteria as described by the metadata associated with the plurality of computing devices; and
wherein the scheduler is operable to select a computing device out of the plurality of computing devices on which to instantiate the virtual machine instance based on the cost of associated with the selected computing device.

10. A cloud computing system, the system comprising:
a plurality of non-homogeneous computing devices configured to host virtual machine instances, each computing device in the plurality of computing devices including a monitor operable to collect metadata about the associated computing device, the metadata describing a characteristic of the computing devices;
a registry operable to receive and store the metadata from the plurality of computing devices; and
a scheduler operable to define an availability zone within the plurality of computing devices based on the collected metadata, the availability zone including the computing devices within the plurality of computing devices that have the characteristic;
wherein the scheduler is further operable to select a host computing device out of the plurality of computing devices on which to instantiate a virtual machine instance based on whether the host computing device is within the availability zone.

11. The cloud computing system of claim 10,
wherein the availability zone is defined to include computing devices having a specific hardware configuration; and
wherein the scheduler is operable to place within the availability zone any computing devices in the plurality of computing devices that have the hardware configuration as described by the collected metadata.

12. The cloud computing system of claim 10,
wherein the availability zone is defined to include computing devices having a specific operating condition; and
wherein the scheduler is operable to dynamically place within the availability zone any computing devices in the plurality of computing devices that have the operating condition as described by the collected metadata.

13. The cloud computing system of claim 12, wherein the availability zone is defined to include the computing devices in the plurality of computing devices that have one of a bandwidth availability below a first threshold, a processor usage below a second threshold, a memory usage below a third threshold, and a hard disk usage below a fourth threshold.

14. The cloud computing system of claim 10, wherein each monitor is operable to collect metadata describing characteristics of a virtual machine instance hosted on the associated computing device; wherein the scheduler is operable to define a second availability zone within the plurality of computing devices based on the collected virtual machine metadata.

15. A method of efficiently utilizing a cloud computing system, comprising:
collecting metadata associated with a plurality of computing devices with a plurality of monitors respectively associated with the plurality of computing devices, the plurality of computing devices being operable to host virtual machine instances;
storing the metadata from the plurality of computing devices in a registry; and
selecting a host computing device out of the plurality of computing devices on which to instantiate a virtual machine instance based on the metadata stored in the registry.

16. The method of claim 15, wherein the plurality of computing devices are non-homogeneous.

17. The method of claim 15, wherein collecting metadata includes:
collecting metadata upon bootup of each of the plurality of computing devices; and
collecting metadata upon bootup of a virtual machine instantiation hosted on any of the plurality of computing devices.

18. The method of claim 15, wherein collecting metadata includes collecting one of static metadata describing hardware configurations of the plurality of computing devices and dynamic metadata describing operating conditions of the plurality of computing devices.

19. The method of claim 15, wherein collecting metadata includes collecting dynamic metadata describing network conditions as they appear to a virtual machine instance.

20. The method of claim 15,
further including defining an availability zone within the plurality of computing devices based on the collected metadata, the availability zone including any computing devices within the plurality of computing devices that have a specific characteristic; and
wherein the selecting the host computing device includes selecting based upon whether the host computing device is within the availability zone.
